(19) United States
(12) Patent Application Publication
(10) Pub. No.: US 2026/0140460 A1
(43) Pub. Date: May 21, 2026

(54) DEVELOPING APPARATUS

(71) Applicant: CANON KABUSHIKI KAISHA, Tokyo (JP)

(72) Inventor: Koji Shigehiro, Tokyo (JP)

(21) Appl. No.: 19/387,945

(22) Filed: Nov. 13, 2025

(30) Foreign Application Priority Data
Nov. 20, 2024 (JP) 2024-202211

(51) Int. Cl. G03G 15/09; G03G 15/01; G03G 21/20

(52) U.S. Cl. CPC G03G 15/0921; G03G 15/0121; G03G 15/0189; G03G 21/206; G03G 2215/0609

(57) ABSTRACT

An edge of a first duct wall on a suction port side is referred to as a point A. A point on an outer surface of a first rotatable member where an absolute value of magnetic flux density of a second magnetic pole in a normal direction with respect to the outer surface of the first rotatable member is a maximum value is referred to as a point H. A straight line passing the point A and the point H is referred to as a straight line T. A straight line passing the point H and a rotation center O of the first rotatable member is referred to as a straight line L. An angle formed by the straight line T and the straight line L is referred to as an angle θ. θ is an acute angle. θ ≤ 60° is satisfied.

### BACKGROUND

### Field of the Technology

The present disclosure relates to a developing apparatus that develops an electrostatic latent image formed on an image bearing member with a developer.

### Description of the Related Art

Image forming apparatuses are equipped with a developing apparatus that attaches a developer to an electrostatic latent image formed on a photosensitive drum and develops the electrostatic latent image into a toner image. A two-component developer including a toner and a carrier is widely used as the developer. The developing apparatus is equipped with a developing roller including a developing sleeve and a magnet disposed non-rotatably inside the developing sleeve, wherein the developer is borne on the developing roller, and the developer is fed to a development region that faces a photosensitive drum along with the rotation of the developing sleeve. In the development region, the electrostatic latent image on the photosensitive drum is developed into a toner image. In such a developing apparatus, toner is easily scattered along with the carrying of the developer on the developing sleeve that rotates.

When toner scattering occurs, the scattered toner will accumulate in the vicinity of the developing apparatus and the photosensitive drum. Thereafter, due to the accumulated toner falling onto the developing sleeve or onto the photosensitive drum by vibration caused during image forming or maintenance, image detects may occur. Japanese Patent Application Laid-Open Publication No. 2019-144333 discloses a developing apparatus equipped with a duct for sucking in scattered toner. According to Japanese Patent Application Laid-Open Publication No. 2019-144333, a vibration unit for applying vibration to the duct is provided to suppress the toner having been sucked in from attaching to the duct and aggregating.

Further, when sucking the toner into the duct, carrier particles may also enter the duct. If the carrier particles reach a suction path of the duct, the carrier particles will accumulate inside the suction path, narrowing the cross-sectional area of the flow path, such that the necessary flow rate of air cannot be obtained, and as a result, the scattered toner cannot be sucked in sufficiently. Further, if a filter for collecting toner is disposed in the path of the duct, the filter will be clogged with carrier particles, by which suction force is deteriorated, such that the scattered toner cannot be sucked in sufficiently. Thus, US2021/0096500 discloses a configuration in which a recessed portion is formed on a lower surface of the path inside the duct to collect the carrier by the recessed portion, such that the carrier particles entering the duct when sucking the scattered toner is prevented from entering the filter.

However, even if a technique as disclosed in US2021/0096500 is adopted to collect the carrier sucked into the duct, the carrier being sucked into the duct may not fall into the recessed portion on the lower surface of the path inside the duct and may be further conveyed together with the suction airflow to reach deeper into the duct. Further, both Japanese Patent Application Laid-Open Publication No. 2019-144333 and US2021/0096500 are equipped with a peeling roller for peeling off the developer remaining on the developing roller after developing the image from the developing roller. Further, a suction port of the duct is disposed in the vicinity of an opposing portion where the developing roller and the peeling roller face each other. In this case, the carrier particles being scattered in the vicinity of the opposing portion may be attached to an inner wall of the duct. If the scattered toner being sucked into the duct is attached near the carrier attached to the inner wall of the duct and the amount of attached toner increases, lump of toner may fall from the inner wall of the duct onto the photosensitive drum, and may soil the formed image with toner.

### SUMMARY

One aspect of the present disclosure is to suppress the sucking of carrier into the duct portion.

According to one aspect of the present disclosure, a developing apparatus includes a developing container including a first chamber configured to contain a developer including a toner and a carrier, and a second chamber partitioned from the first chamber by a partition wall, a first rotatable member to which the developer is supplied, the first rotatable member being configured to carry and feed the developer to a developing position where an electrostatic latent image formed on an image bearing member is developed, a first magnet provided non-rotatably and stationarily inside the first rotatable member, the first magnet having a first magnetic pole provided to face the image bearing member at the developing position, a second magnetic pole provided downstream of the first magnetic pole with respect to a rotational direction of the first rotatable member, a third magnetic pole provided downstream of the second magnetic pole and adjacent to the second magnetic pole, with respect to the rotational direction of the first rotatable member, and having a different magnetic polarity as that of the second magnetic pole, and a fourth magnetic pole provided downstream of the third magnetic pole and adjacent to the third magnetic pole, with respect to the rotational direction of the first rotatable member, and having a same magnetic polarity as that of the third magnetic pole, a second rotatable member disposed to face the first rotatable member and configured to receive the developer delivered from the first rotatable member by a magnetic field generated by the first magnet, the second rotatable member being configured to carry and feed the developer after developing the electrostatic latent image into the second chamber to collect the developer in the second chamber, a second magnet provided non-rotatably and stationarily inside the second rotatable member, the second magnet having a fifth magnetic pole having a different magnetic polarity as that of the third magnetic pole, wherein the developer after developing the electrostatic latent image is delivered from the first rotatable member to the second rotatable member by a magnetic field generated between the third magnetic pole and the fifth magnetic pole, and, a duct portion including a suction port that is an inlet through which the developer scattered in the developing container is sucked, the duct portion being extended upstream, in the rotational direction of the second rotatable member, from the suction port, a first duct wall disposed to face the second rotatable member, and a second duct wall disposed to face the second rotatable member, and also disposed to face the first duct wall and configured to form a space through which the developer sucked from the suction port flows between the second duct wall and the first duct wall, the second duct wall being positioned on an outer side than the first duct wall with respect to a rotation center of the second rotatable member in a radial direction of the second rotatable member. In a cross-section orthogonal to a rotational axis of the first rotatable member, in a state where an edge of the first duct wall on the suction port side, which is an end point on the second duct wall side, is referred to as a point A, a point on an outer surface of the first rotatable member where an absolute value of magnetic flux density of the second magnetic pole in a normal direction with respect to the outer surface of the first rotatable member is a maximum value is referred to as a point H, a straight line passing the point A and the point H is referred to as a straight line T, a straight line passing the point H and a rotation center O of the first rotatable member is referred to as a straight line L, and an angle formed by the straight line T and the straight line L is referred to as an angle θ, where θ is an acute angle, θ ≤ 60° is satisfied.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view illustrating a configuration of an image forming apparatus according to a first embodiment.

FIG. 2 is a schematic cross-sectional view illustrating a developing apparatus according to the first embodiment.

FIG. 3 is an explanatory view of a coordinate plane with a rotation center of a second developing sleeve and a peeling sleeve set as origin according to the first embodiment.

FIG. 4 is a view illustrating a magnetic pole arrangement of first and second developing rollers and a peeling roller according to the first embodiment.

FIG. 5A is a cross-sectional view of a periphery of a second developing roller and a duct for describing an angle θ.

FIG. 5B is a schematic diagram illustrating a relationship between an angle of a magnetic brush and the angle θ.

FIG. 6 is a graph illustrating a magnetic flux density distribution and angle of magnetic brush of the second developing roller.

FIG. 7A is a cross-sectional view of a periphery of a suction port of the duct and the second developing roller according to the first embodiment, wherein the angle θ is 60°.

FIG. 7B is a cross-sectional view of a periphery the suction port of the duct and the second developing roller according to the first embodiment, wherein the angle θ is 40°.

FIG. 8 is a graph illustrating a relationship between the angle θ and a reduction rate of a carrier collecting amount.

FIG. 9 is a cross-sectional view of a periphery of a suction port of a duct and a second developing roller according to a second embodiment.

FIG. 10A is a cross-sectional view of a periphery of a suction port of a duct and a second developing roller according to another Example 1 of the second embodiment.

FIG. 10B is a cross-sectional view of a periphery of a suction port of a duct and a second developing roller according to another Example 2 of the second embodiment.

FIG. 11A is a cross-sectional view of a periphery of the suction port of the duct and the second developing roller according to the second embodiment, wherein θ = φ.

FIG. 11B is a cross-sectional view of a periphery of the suction port of the duct and the second developing roller according to the second embodiment, wherein θ > φ.

FIG. 11C is a cross-sectional view of a periphery of the suction port of the duct and the second developing roller according to the second embodiment, wherein θ < φ.

FIG. 12 is a graph illustrating a relationship between angles θ and φ and the reduction rate of carrier collecting amount.

FIG. 13 is a cross-sectional view of a periphery of a suction port of a duct and a second developing roller according to a third embodiment.

FIG. 14 is a cross-sectional view of the periphery of the suction port of the duct and the second developing roller according to the third embodiment, illustrating in schematic view a magnetic line distribution of a case where θ = 40° and ψ = 5°.

FIG. 15 is a cross-sectional view of the periphery of the suction port of the duct and the second developing roller according to the third embodiment, illustrating in schematic view the magnetic line distribution of a case where θ = 40° and ψ = 10°.

FIG. 16 is a cross-sectional view of the periphery of the suction port of the duct and the second developing roller according to the third embodiment, illustrating in schematic view the magnetic line distribution of a case where θ = 40°, ψ = 10°, α = 18°, and β = 7°.

FIG. 17 is a table illustrating a relationship between the reduction rate of carrier collecting amount and a retention phenomenon with respect to angle ψ.

### DESCRIPTION OF THE EMBODIMENTS

### First Embodiment

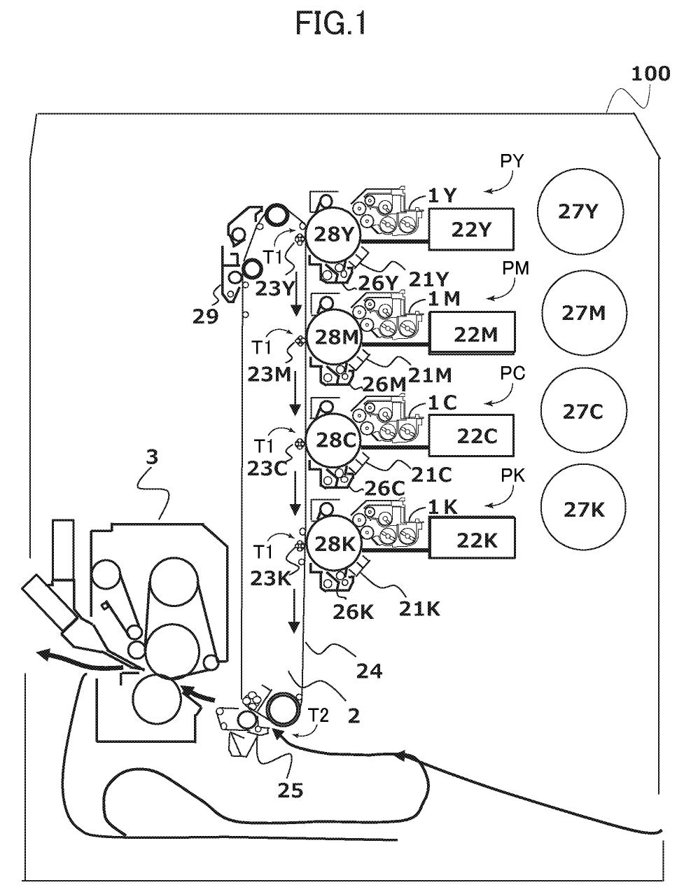

A first embodiment will be described with reference to FIGS. 1 to 8. First, a schematic configuration of an image forming apparatus of the present embodiment will be described with reference to FIG. 1.

### Image Forming Apparatus

An image forming apparatus 100 is a full-color image forming apparatus, and in the present embodiment, for example, is a multi-function peripheral (MFP) having a copy function, a printer function, and a scan function. As illustrated in FIG. 1, the image forming apparatus 100 includes image forming units PY, PM, PC, and PK that perform image forming processes for toner images of four colors of yellow, magenta, cyan, and black, respectively, that are arranged in parallel. The image forming apparatus 100 according to the present embodiment has a document reading apparatus connected to an image forming apparatus body, i.e., apparatus body, or a host apparatus such as a personal computer connected in a communicatable manner to the apparatus body. Therefore, according to an image information received from the host apparatus, a four-color full-color image of yellow (Y), magenta (M), cyan (C), and black (K) may be formed on a recording material, such as recording paper, plastic sheets, and cloths, using an electrophotographic system.

The image forming units PY, PM, PC, and PK of the respective colors include primary chargers 21Y, 21M, 21C, and 21K, developing apparatuses 1Y, 1M, 1C, and 1K, exposure devices 22Y, 22M, 22C, and 22K, photosensitive drums 28Y, 28M, 28C, and 28K, and cleaning devices 26Y, 26M, 26C, and 26K. The image forming apparatus 100 includes a transfer device 2 and a fixing device 3. Since configurations of the image forming units PY, PM, PC, and PK of the respective colors are similar to each other, the image forming unit PY will be described below as a representative.

The photosensitive drum 28Y serving as an image bearing member is a photosensitive member including a photosensitive layer made of a resin such as a polycarbonate resin containing an organic photoconductor (OPC), and is configured to rotate at a predetermined speed. The primary charger 21Y includes a corona discharge electrode disposed around the photosensitive drum 28Y, and charges the surface of the photosensitive drum 28Y with generated ions.

The exposure device 22Y incorporates a scanning optical device, and exposes the charged photosensitive drum 28Y based on image data to lower a potential of an exposed portion, thereby forming a charge pattern, i.e., electrostatic latent image, corresponding to the image data. The developing apparatus 1Y transfers a developer accommodated therein to the photosensitive drum 28Y to develop the electrostatic latent image formed on the photosensitive drum 28Y. The developer is formed by mixing a carrier and a toner corresponding to each color, and the electrostatic latent image is visualized by the toner.

The transfer device 2 includes primary transfer rollers 23Y, 23M, 23C, and 23K, an intermediate transfer belt 24, and a secondary transfer roller 25. The intermediate transfer belt 24 is wound around the primary transfer rollers 23Y, 23M, 23C, and 23K and a plurality of rollers, and is supported so as to be able to travel. The primary transfer rollers 23Y, 23M, 23C, and 23K serving as primary transfer members correspond to respective colors of yellow (Y), magenta (M), cyan (C), and black (K) in order from the top in FIG. 1. The secondary transfer roller 25 is disposed outside the intermediate transfer belt 24, and is configured to allow a recording material to pass between the secondary transfer roller 25 and the intermediate transfer belt 24.

The toner images of the respective colors formed on the photosensitive drums 28Y, 28M, 28C, and 28K are transferred, i.e., primarily transferred, onto the intermediate transfer belt 24 by the operation of a primary transfer bias applied to the primary transfer rollers 23Y, 23M, 23C, and 23K at a primary transfer portion, i.e., primary transfer nip, T1 where the intermediate transfer belt 24 and the photosensitive drums 28Y, 28M, 28C, and 28K abut on each other. For example, when forming a four-color full-color image, toner images are sequentially transferred, starting from the photosensitive drum 28Y, on the intermediate transfer belt 24, such that a toner image in which the respective colors of yellow, magenta, cyan, and black are layered in a superimposed manner is formed.

Meanwhile, a recording material stored in a cassette not shown serving as a recording material accommodating portion is conveyed via a pickup roller and a registration roller not shown toward the transfer device 2. The recording material is conveyed at a synchronized timing with the toner image on the intermediate transfer belt 24 to a secondary transfer portion, i.e., nip portion, T2 where the intermediate transfer belt 24 and the secondary transfer roller 25 serving as a secondary transfer member abut on each other. The toner image formed on the intermediate transfer belt 24 is secondarily transferred onto the recording material by the operation of a secondary transfer bias applied on the secondary transfer roller 25 at the secondary transfer portion T2. Pressure and heat are applied at the fixing device 3 to the recording material to which the toner image is transferred. As a result, the toner on the recording material is melted, and the color image is fixed to the recording material. Thereafter, the recording material S is discharged to the exterior of the apparatus.

When forming images on both sides of the recording material, the recording material having passed through the fixing device 3 is conveyed to a reverse conveyance passage not shown, where the recording material is reversed, and the reserved recording material is then conveyed to the registration roller, and a toner image is transferred to a back surface of the recording material in a similar manner as described above at the secondary transfer portion T2. Then, the toner image is fixed to the back surface of the recording material again at the fixing device 3.

Attached matter such as toner remaining on the photosensitive drums 28Y, 28M, 28C, and 28K after the primary transfer process is collected by the cleaning devices 26Y, 26M, 26C, and 26K. Thereby, the photosensitive drums 28Y, 28M, 28C, and 28K prepare for the subsequent image forming process. Further, attached matter such as toner remaining on the intermediate transfer belt 24 after the secondary transfer process is removed by an intermediate transfer belt cleaner 29.

Alternatively, the image forming apparatus 100 according to the present embodiment may use the image forming unit of a desired single color, such as black, or a few of the image forming units among the four colors, to form a single color or a multi-color image. In addition, in FIG. 1, a configuration is illustrated where the image forming units PY, PM, PC, and PK of respective colors are arranged in a vertical direction, but the arrangement direction may alternatively be horizontal or diagonal. According further to the present embodiment, the outer diameter of the respective photosensitive drums 28Y, 28M, 28C, and 28K is set to 80 [mm], for example, and the image forming operation may be executed while the drums are rotated at a peripheral speed of 513 mm/sec.

Developer storages 27Y, 27M, 27C, and 27K are respectively provided corresponding to the developing apparatuses 1Y, 1M, 1C, and 1K, and bottles accommodating developers corresponding to the respective colors of yellow, magenta, cyan, and black are replaceably loaded in the named order from the top. The developer storages 27Y, 27M, 27C, and 27K are configured to be able to convey, i.e., replenish, the developers to the developing apparatuses 1Y, 1M, 1C, and 1K corresponding to the colors of the accommodated developers.

For example, a weight ratio of the toner of the developer contained in the bottle is 90 to 98%, and a weight ratio of the toner of the developer in each of the developing apparatuses 1Y, 1M, 1C, and 1K is 5 to 11%. Therefore, once the toner is consumed to perform the development in the developing apparatuses 1Y, 1M, 1C, and 1K, the developer containing the toner is replenished to compensate for the amount of consumption, and the weight ratio of the toner of the developer in each of the developing apparatuses 1Y, 1M, 1C, and 1K is maintained constant.

### Heading Apparatus

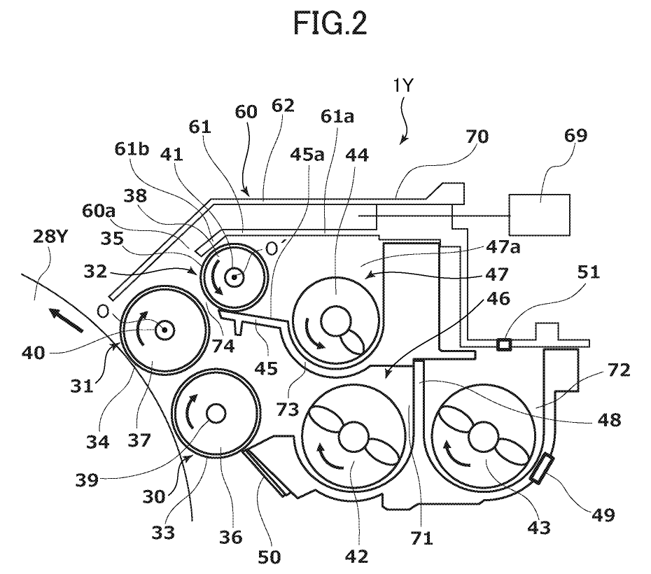

Next, the developing apparatuses 1Y, 1M, 1C, and 1K will be described in detail with reference to FIG. 2. Since the configurations of the developing apparatuses 1Y, 1M, 1C, and 1K are the same, the developing apparatus 1Y will be described below as a representative.

As illustrated in FIG. 2, the developing apparatus 1Y includes a first developing roller 30, a second developing roller 31, a peeling roller 32, a developer supplying screw 42, a developer stirring screw 43, and a developer collecting screw 44, and these members are housed in a developing container 70. The developing container 70 accommodates a two-component developer containing a nonmagnetic toner and a magnetic carrier.

The first developing roller 30 is a developer bearing member that is rotationally driven, and is disposed at a position adjacent to the photosensitive drum 28Y such that a rotational axis thereof is substantially parallel to a rotational axis of the photosensitive drum 28Y. The first developing roller 30 includes a first developing sleeve 33 that rotates, and a first developing magnet, i.e., fixed magnet, 36 that is provided non-rotatably inside the first sleeve 33 and attracts the developer to the surface of the first sleeve 33 by a magnetic force. Then, the first developing roller 30 attracts, i.e., carries, the developer from the developer supplying screw 42 based on the magnetic force, and develops the electrostatic latent image formed on the rotating photosensitive drum 28Y, i.e., on the image bearing member, with the developer.

The first developing sleeve 33 is a nonmagnetic cylindrical member that is rotationally driven about a rotation shaft 39. A rotational direction of the first developing sleeve 33 is a clockwise direction as indicated by an arrow in FIG. 2, and is a direction opposite to a rotational direction of the photosensitive drum 28Y in the present embodiment. Therefore, the first developing sleeve 33 and the photosensitive drum 28Y rotate in the same direction, i.e., forward direction, at positions facing each other, i.e., opposing portions. That is, the first developing sleeve 33 is rotated such that the surface facing the photosensitive drum 28Y is moved from down to up in a vertical direction.

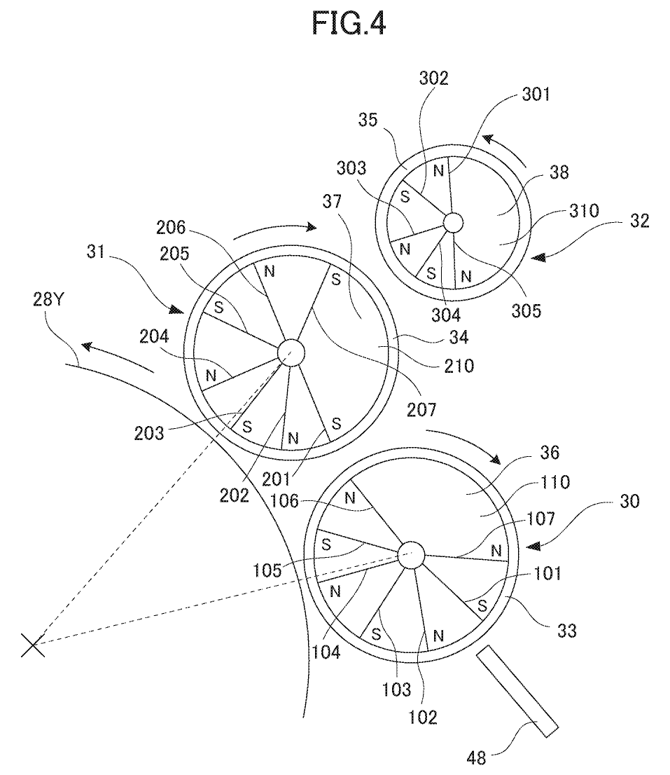

The first developing magnet 36 is disposed inside the first developing sleeve 33, and has a plurality of fan-shaped magnetic poles 101 to 107, and a fan-shaped low magnetic force portion 110, as illustrated in FIG. 4 described below. A space that allows rotation of the first developing sleeve 33 is disposed between an inner periphery of the first developing sleeve 33 and an outer periphery of the first developing magnet 36. In the respective magnets illustrated in FIG. 4, the lines representing the magnetic poles indicate positions where a normal component of a magnetic flux density has a maximum value. The same applies for the subsequent drawings.

The developer attracted to the first developing sleeve 33 is fed toward the photosensitive drum 28Y by a rotation operation of the first developing sleeve 33, thereby developing the latent image formed on the photosensitive drum 28Y. After the latent image formed on the photosensitive drum 28Y is developed, the developer on the first developing sleeve 33 is fed to the vicinity of the second developing roller 31 by the rotation operation of the first developing sleeve 33. Then, in the vicinity of the closest position of the first developing roller 30 and the second developing roller 31, the developer is peeled off from the first developing sleeve 33 by a magnetic field generated by the first developing magnet 36 within the first developing roller 30 and the second developing magnet 37 within the second developing roller 31, and is delivered onto the second sleeve 34.

The second developing roller 31 serving as a developing roller is a developer bearing member that is rotationally driven, is disposed downstream of the first developing roller 30 in the rotational direction of the photosensitive drum 28Y and positioned higher than a rotation center of the first developing roller 30 in the vertical direction, and receives the developer delivered from the first developing roller 30 by the magnetic force. Similar to the first developing roller 30, the second developing roller 31 is disposed at a position adjacent to the photosensitive drum 28Y such that a rotational axis thereof is substantially parallel to the rotational axis of the photosensitive drum 28Y. Therefore, the rotational axes of the second developing roller 31 and the first developing roller 30 are substantially parallel to each other.

Such a second developing roller 31 includes a second developing sleeve (a first rotatable developing member) 34 that rotates and the second developing magnet (a first magnet), i.e., fixed magnet, 37 that is provided non-rotatably inside the second sleeve 34 and attracts the developer to the surface of the second sleeve 34 by a magnetic force. Then, the second developing roller 31 receives the developer delivered from the first developing roller 30, i.e., the first developing sleeve 33, based on the magnetic force, attracts, i.e., carries, the developer, and develops the electrostatic latent image formed on the rotating photosensitive drum 28Y with the developer. The peeling roller 32 described below is positioned on a side of the second developing roller 31.

The second developing sleeve 34 is a nonmagnetic cylindrical member that is rotationally driven about a rotation shaft 40. A rotational direction of the second developing sleeve 34 is a clockwise direction, as indicated by an arrow in FIG. 2, and is a direction opposite to the rotational direction of the photosensitive drum 28Y in the present embodiment. Therefore, the second developing sleeve 34 and the photosensitive drum 28Y rotate in the same direction, i.e., forward direction, at positions facing each other, i.e., opposing portions. That is, the second developing sleeve 34 is rotated such that a surface facing the photosensitive drum 28Y moves from down to up in the vertical direction. Further, the second developing sleeve 34 and the first developing sleeve 33 rotate in opposite directions at positions facing each other.

The second developing magnet 37 is disposed inside the second developing sleeve 34 and has a plurality of fan-shaped magnetic poles 201 to 207, and a fan-shaped low magnetic force portion 210. A space that allows rotation of the second developing sleeve 34 is disposed between an inner periphery of the second developing sleeve 34 and an outer periphery of the second developing magnet 37.

The developer attracted to the second developing sleeve 34 is fed toward the photosensitive drum 28Y by a rotation operation of the second developing sleeve 34, thereby developing the latent image formed on the photosensitive drum 28Y. After the latent image formed on the photosensitive drum 28Y is developed, the developer remaining on the second developing sleeve 34 is fed to the vicinity of the peeling roller 32 by the rotation operation of the second developing sleeve 34. Then, in the vicinity of the closest positions of the second developing roller 31 and the peeling roller 32, the developer is delivered from the second developing sleeve 34 to a peeling sleeve 35 of the peeling roller 32 by a magnetic field generated by the second developing magnet 37 within the second developing roller 31 and the peeling magnet 38 within the peeling roller 32.

The peeling roller, i.e., collecting roller, 32 is disposed on a side opposite to the photosensitive drum 28Y with respect to a rotation center of the second developing sleeve 34, and peels, from the second developing roller 31, the developer after developing the electrostatic latent image on the photosensitive drum 28Y by the second developing roller 31. Specifically, the peeling roller 32 is a developer bearing member that is rotationally driven, and is disposed between the second developing roller 31 and the developer collecting screw 44 such that a rotation center thereof is positioned higher than a rotation center of the second developing roller 31.

The peeling roller 32 is disposed such that a rotational axis thereof is substantially parallel to the rotational axis of the second developing roller 31. The peeling roller 32 includes the peeling sleeve (a second rotatable developing member) 35 that rotates and the peeling magnet (a second magnet), i.e., fixed magnet, 38 that is provided non-rotatably inside the peeling sleeve 35 and attracts the developer to the surface of the peeling sleeve 35 by a magnetic force, and is configured to receive the developer delivered from the second developing roller 31 based on the magnetic force.

The peeling sleeve 35 is a nonmagnetic cylindrical member that is rotationally driven about a rotation shaft 41. A rotational direction of the peeling sleeve 35 is a counterclockwise direction as indicated by an arrow in FIG. 2, and is the opposite direction as the rotational direction of the second developing sleeve 34 in the present embodiment. Therefore, the peeling sleeve 35 and the second developing sleeve 34 rotate in the same direction, i.e., forward direction, at positions facing each other, i.e., opposing portions. That is, the peeling sleeve 35 is rotated such that the surface thereof moves in the same direction as the surface of the second developing sleeve 34 in the opposing portion that faces the second developing sleeve 34.

The peeling magnet 38 is disposed inside the peeling sleeve 35 and has a plurality of fan-shaped magnetic poles 301 to 305, and a fan-shaped low magnetic force portion 310. A space that allows rotation of the peeling sleeve 35 is disposed between an inner periphery of the peeling sleeve 35 and an outer periphery of the peeling magnet 38.

The developer attracted to the peeling sleeve 35 is fed downstream in the rotational direction by the rotation operation of the peeling sleeve 35, is peeled off from the peeling sleeve 35 by the peeling magnet 38 within the peeling roller 32 at a position close to the developer collecting screw 44, and falls toward a guide member 45 positioned lower in the vertical direction by its own weight. Then, the developer falling onto the guide member 45 is guided by its own weight toward the developer collecting screw 44.

The guide member 45 and the developer collecting screw 44 constitute a developer collecting portion 47 serving as a collecting portion that collects the developer peeled off from the peeling sleeve 35 of the peeling roller 32. In the developer collecting portion 47, the developer collecting screw 44 is positioned lower than the rotation center of the peeling roller 32 in the vertical direction, and conveys the developer delivered, i.e., collected, from the peeling roller 32 while stirring the developer.

The guide member 45 serving as a guide portion is disposed below the rotation center O’ of the peeling roller 32 in the vertical direction. The guide member 45 guides the developer peeled off by the peeling roller 32 toward the developer collecting screw 44. The guide member 45 has an inclined surface 45a on which the developer slides down by its own weight such that the peeled developer is guided more reliably toward the developer collecting screw 44. The inclined surface 45a is inclined with respect to a horizontal direction such that a portion on the side of the developer collecting screw 44 is positioned lower than the position below the peeling roller 32.

The developer collecting screw 44 serving as a collecting member and a conveyance portion conveys the collected developer to a developer circulating portion 46 described below. That is, the developer collecting screw 44 is a screw conveyance member used to convey the developer sliding down the inclined surface of the guide member 45 and collected in one direction while stirring the developer.

The developer circulating portion 46 is a supply portion for supplying the developer to the first developing roller 30, and the developer circulating portion 46 includes a regulating member 50, the developer supplying screw 42, and the developer stirring screw 43. In the developer circulating portion 46, the developer is supplied to the first developing roller 30 while being fed in the substantially horizontal direction and stirred by the developer supplying screw 42 and the developer stirring screw 43. As described above, the developer collected by the developer collecting portion 47 falls by its own weight and is introduced into the developer circulating portion 46. That is, the developer circulating portion 46 is positioned lower than the developer collecting portion 47 with respect to the vertical direction.

The developer supplying screw 42, the developer stirring screw 43, and the developer collecting screw 44 are screw conveyance members that convey the developer in one direction while stirring the developer, and the developer supplying screw 42 and the developer stirring screw 43 are positioned lower than the rotation center of the developer collecting screw 44 in the vertical direction. In addition, the developer supplying screw 42, the developer stirring screw 43, and the developer collecting screw 44 are disposed such that rotation axes thereof are substantially parallel to each other. The rotation axis of each screw is substantially parallel to the rotation axis of the first developing roller 30.

The developer supplying screw 42 is positioned between the first developing roller 30 and the developer stirring screw 43, and a partition wall 48 of the developing container 70 is disposed between the developer supplying screw 42 and the developer stirring screw 43. The partition wall 48 of the developing container 70 extends in a rotation axis direction of the developer supplying screw 42 and the developer stirring screw 43. The partition wall 48 has a communication port (not illustrated) for communication between a first conveyance path (a first chamber) 71 through which the developer is fed by the developer supplying screw 42 and a second conveyance path 72 through which the developer is fed by the developer stirring screw 43.

The developer stirred by the developer collecting screw 44 passes through a communication port (not illustrated) formed in a partition wall 73 of the developing container 70 between a developer collecting chamber (a second chamber) 47a in which the developer collecting screw 44 is disposed and the first conveyance path (the first chamber) 71 in which the developer supplying screw 42 is disposed, and falls toward the developer supplying screw 42 by its own weight. The guide member 45 described above is formed integrally with the partition wall 73, and the developer collecting screw 44 is disposed above the partition wall 73.

A position of the communication port through which the developer stirred by the developer collecting screw 44 falls by its own weight and is introduced into the developer circulating portion 46 is preferably disposed to avoid a region where the developer is supplied toward the first developing roller 30, i.e., an intermediate portion of the developer supplying screw 42 in the rotation axis direction. In the present embodiment, it is assumed that the position of the communication port is a position within a range of a downstream end portion, i.e., terminal end portion, of the first conveyance path 71, in which the developer supplying screw 42 is disposed, in a developer conveyance direction.

The developer conveyance directions of the developer supplying screw 42 and the developer stirring screw 43 are opposite to each other. A start end side, i.e., an upstream end side in the developer conveyance direction, and a terminal end side, i.e., a downstream end side in the developer conveyance direction, of the first conveyance path 71 in which the developer supplying screw 42 is disposed communicate with a terminal end side and a start end side of the second conveyance path 72 in which the developer stirring screw 43 is disposed via the communication port provided in the partition wall 48. Therefore, the developer circulates in a rotational direction of the developer supplying screw 42 and the developer stirring screw 43 indicated by arrows in FIG. 2 and in the substantially horizontal direction inside the developing container 70, and a part of the developer is supplied toward the first developing roller 30.

A developer replenishment port 51 (refer to FIG. 2) is provided above the developer stirring screw 43 in the developing container 70, and is connected to the developer storage 27Y (refer to FIG. 1). The developer replenishment port 51 is configured to be able to replenish the developer contained in a bottle loaded in the developer storage 27Y to the second conveyance path 72 in which the developer stirring screw 43 is disposed.

As described above, since the weight ratio of the toner of the developer contained in the bottle of the developer storage 27Y is higher than the weight ratio of the toner of the developer in the developing apparatus 1Y, the weight ratio of the toner of the developer in the developing apparatus 1 can be maintained constant by adjusting the developer being replenished to the developer stirring screw 43.

A toner density detection sensor 49 (refer to FIG. 2) is provided to detect a toner density in the developer contained in the developer circulating portion 46. The toner density detection sensor 49 is a sensor that detects magnetic permeability of the developer. Since the toner density corresponds to the amount of toner consumption in the developing apparatus 1Y, the toner density is used for controlling developer replenishment from the developer storage 27Y. For example, when it is detected that the toner density is lower than a predetermined value, the developer is replenished from the developer storage 27Y. Since the magnetic permeability of the developer changes depending on the toner density, the toner density can be detected using the magnetic permeability.

The regulating member 50 is disposed adjacent to the first developing roller 30, and is used to regulate the amount of developer supplied from the developer circulating portion 46 to the first developing roller 30. For example, the regulating member 50 can be configured to regulate the amount of developer attracted to the first developing roller 30 based on a gap between the surface of the first developing sleeve 33 of the first developing roller 30 and an end portion of the regulating member 50.

In a developer circulation path in the developing container 70, the developer is fed in the substantially horizontal direction while being stirred in the developer circulating portion 46, is then supplied to the first developing roller 30, and is delivered from the first developing roller 30 to the second developing roller 31 positioned higher than the first developing roller 30 based on the magnetic force. Then, the developer is delivered again from the second developing roller 31 to the peeling roller 32 positioned on the side surface of the second developing roller 31 based on the magnetic force, is then peeled off from the peeling roller 32 by the peeling magnet 38 within the peeling roller 32, is further collected by the developer collecting portion 47, and is introduced again into the developer circulating portion 46.

As described above, in the present embodiment, a two-component developing system is used as a developing system, and a mixture of a nonmagnetic toner having a negative charging polarity and a magnetic carrier is used as the developer. The nonmagnetic toner is charged negatively by frictional electrification with the magnetic carrier, and the magnetic carrier is charged positively. The nonmagnetic toner is obtained by incorporating a colorant and a wax component in a resin such as a polyester resin or a styrene acrylic resin, pulverizing or polymerizing the resin into powder, and adding fine powder of titanium oxide, silica, or the like to the surface. The magnetic carrier is obtained by applying resin coating to a surface layer of a core formed of ferrite particles or resin particles kneaded with magnetic powder. A toner density, i.e., weight ratio of the toner contained in the developer, in the developer in an initial state is 8% in the present embodiment.

In general, in the two-component development method using a toner and a carrier, both the toner and the carrier are charged to predetermined polarities by being brought into frictional contact with each other, and thus has a feature that stress received by the toner is less than that of a one-component developing system using a one-component developer. On the other hand, the long-term use increases soiling, i.e., spent, attached to the surface of the carrier, and thus an ability to charge the toner gradually decreases. As a result, issues such as fogging and toner scattering occur. In order to prolong the life of a two-component developing apparatus, it is conceivable to increase the amount of carriers contained in the developing apparatus, but such a configuration is not desirable, since the size of the developing apparatus may be increased.

In order to solve the above issue related to the two-component developer, an auto carrier refresh (ACR) method is adopted in the present embodiment. The ACR method is a method of suppressing an increase in deteriorated carrier by replenishing a new developer from the developer storage 27Y into the developing apparatus 1Y little by little and discharging the developer with deteriorated charging performance little by little from a discharge port (not illustrated) of the developing apparatus 1Y. As a result, the deteriorated carrier in the developing apparatus 1Y is gradually replaced with the new carrier, and the charging performance of the carrier in the developing apparatus 1Y can be kept substantially constant.

In the developing apparatus 1Y of the present embodiment configured as described above, the developer in the first conveyance path 71 is supplied via the developer supplying screw 42 to the first developing sleeve 33, and a predetermined amount of developer supplied to the first developing sleeve 33 is borne on the first developing sleeve 33 by the magnetic field generated by the first developing magnet 36, and forms a developer accumulation. The two-component developer on the first developing sleeve 33 passes through the developer accumulation by the rotation of the first developing sleeve 33, forms a thin layer coating on the surface of the first developing sleeve 33 by the regulating member 50, and is carried to a development region facing the photosensitive drum 28Y. In the development region, the developer on the first developing sleeve 33 is napped and a magnetic brush is formed.

In a first development region where the first developing sleeve 33 and the photosensitive drum 28Y face each other, the electrostatic latent image formed on the photosensitive drum 28Y is developed by developing bias applied to the first developing sleeve 33. In the present embodiment, the developing bias applied to the first developing sleeve 33 has a waveform in which both an AC electric field and a DC electric field are applied, but alternatively, the developing bias may only have a DC electric field.

The two-component developer is used for a developing process in the first development region, and then delivered to the second developing sleeve 34 at a position close to the second developing sleeve 34, thereafter fed to a second development region where the second developing sleeve 34 and the photosensitive drum 28Y face each other. In the second development region, a same developing bias as that applied in the first development region is applied, and toner that is insufficient with respect to the potential of the electrostatic latent image on the photosensitive drum 28Y is supplemented and developed, and toner that has been developed excessively is collected to prepare a uniform toner image. A bias having different waveforms may be applied as the developing bias applied to the first developing sleeve 33 and the developing bias applied to the second developing sleeve 34.

The developer having passed through the second development region is peeled off in a peeing magnetic field area formed by the second developing magnet 37 included in the second developing sleeve 34. The developer peeled off from the second developing sleeve 34 is attracted onto the surface of the peeling sleeve 35 by the magnetic field formed by the peeling magnet 38 included in the peeling sleeve 35 of the peeling roller 32, and conveyed along the rotational direction of the peeling sleeve 35. Then, the developer is detached from the surface of the peeling sleeve 35 by the peeing magnetic field formed by the peeling magnet 38, and is collected to the developer collecting portion 47.

### Duct

The developing apparatus 1Y includes a duct, i.e., suction duct, 60 for collecting toner that has been separated from the second development region or the magnetic brush at a feeding magnetic pole on the downstream side in the developer conveyance direction of the second development region and scattered in air, that is disposed above the area between the second development region of the second developing sleeve 34 described above and the peeling magnetic field area. The duct 60 is a suction cleaning configuration for cleaning scattered toner generated at the second developing roller 31 and the peeling roller 32, and as illustrated in FIG. 2, includes a first duct wall 61 and a second duct wall 62. Further, the developing apparatus 1Y is equipped with an air suction device 69 connected to the duct 60.

The first duct wall 61 covers a part of an inner space of the developing container 70 in which the first developing roller 30, the second developing roller 31, and the peeling roller 32 are disposed and in which the developer is stored, and prevents scattering of the developer from the inner space to the exterior. In the present embodiment, the first duct wall 61 covers an upper area of the peeling roller 32 and the developer collecting portion 47. Specifically, the first duct wall 61 includes a first wall portion 61a that is positioned above a peak of the peeling roller 32 in the vertical direction, and a second wall portion 62b that is extended upstream of the peeling sleeve 35 in the rotational direction from the first wall portion 61a, and is positioned closer to the peeling roller 32 than the first wall portion 61a. That is, in the present embodiment, the first duct wall 61 is disposed to extend upstream in the rotational direction of the peeling sleeve 35 from the position above the peeling roller 32, and is bent diagonally downward in midway.

As described, the first duct wall 61 covers an upper portion of a part of the inner space of the developing container 70, and the second duct wall 62 is disposed on an outer side of the first duct wall 61. The second duct wall 62 constitutes a part of an outer wall of the developing container 70, but it may be independent from the outer wall of the developing container 70. The second duct wall 62 is extended above the second developing roller 31, the edge thereof facing the photosensitive drum 28Y with a gap therebetween, and covers the upper portion of the second developing roller 31. Specifically, the second duct wall 62 is extended toward the second developing roller 31 side, i.e., developing roller side, than the edge of the first duct wall 61 on the suction port 60a side. In the present embodiment, the second duct wall 62 is extended from above the first duct wall 61 in the vertical direction to a position facing the second developing roller 31.

Further, the suction port 60a of the duct 60 constituted of the first duct wall 61 and the second duct wall 62 is provided above the second developing roller 31. Specifically, the suction port 60a is an opening portion on a first end side of the duct 60 formed between the edge of the first duct wall 61 and a part of the second duct wall 62. The suction port 60a is positioned upstream of an opposing portion 74 at which the second developing roller 31 and the peeling roller 32 face each other with respect to the rotational direction of the peeling roller 32.

A second end side of the duct 60 is connected to a main duct not shown. The main duct has developing apparatuses for the respective colors merged thereto and connected to the air suction device 69. The air suction device 69 is a fan, for example, and by driving the air suction device 69, the developer scattered inside the developer container during developing operation is sucked through the suction port 60a via the duct 60. Further, the air sucked into the duct 60 is discharged via a filter not shown to the exterior. Thereby, the developer scattered to the exterior from the inner side of the developing container 70 may be reduced. Further, the suction port 60a of the duct 60 sucks in the toner scattered in the area between the second development region and the peeling magnetic field area or the toner floating in the area where the airflow reaches, and reduces the attaching of toner to the periphery of the developing apparatus or the developing apparatus itself. When executing the image forming operation, the air suction device 69 is activated to perform suction of the developer being scattered. The suction operation is performed at all times during image forming operation.

Meanwhile, if carrier particles are sucked together with toner into the duct 60 in the developing apparatus 1Y having the above-described configuration, there may be a risk that suction efficiency of scattered toner is deteriorated by clogging of the filter or suction efficiency is deteriorated due to the carrier being attached to the inner wall of the duct 60. In order to suppress scattering of carrier and to perform highly stable image forming with a high quality for a long period of time, there is a need to suppress the feeding of carrier from the second developing sleeve 34 described above to the duct 60 and suppress the sucking of carrier particles by air flow into the duct 60.

Therefore, it is required to reduce the delivery of carrier particles from the second developing sleeve 34 to the duct 60. Therefore, according to the present embodiment, the configuration of a feeding pole 206 (refer to FIG. 4) of the second developing magnet 37 is optimized as described below.

The developing apparatus 1Y according to the present embodiment has the regulating member 50 arranged below a plurality of developing rollers, i.e., the first developing roller 30 and the second developing roller 31, for carrying the developer, and especially, is configured to carry the developer upward via a plurality of developing rollers against gravity. Further, the duct 60 is arranged downstream in the conveyance direction of the developer by the plurality of developing rollers, and is configured to suck in scattered toner. According to such a configuration, scattering of carrier particles tends to occur as the image forming speed, i.e., processing speed, increases.

In the present embodiment, the first developing sleeve 33 has a diameter of φ25 [mm], and rotates at a peripheral speed of 513 [mm/sec], similar to the photosensitive drum 28Y. Further, the second developing sleeve 34 has a diameter of φ25 [mm], which is the same as the first developing sleeve 33, and rotates at a peripheral speed of 616 [mm/sec], which is faster than the peripheral speed of the first developing sleeve 33. Further, the peeling sleeve 35 has a diameter of φ18 [mm], which is smaller than the first developing sleeve 33 and the second developing sleeve 34, and rotates at a peripheral speed of 744 [mm/sec], which is faster than the peripheral speed of the second developing sleeve 34.

### Arrangement of Suction Port of Duct

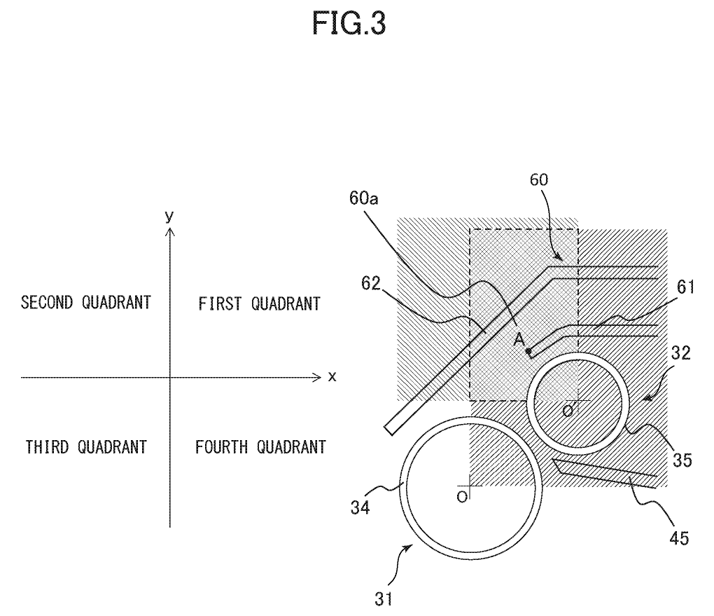

FIG. 3 illustrates an enlarged schematic diagram of a periphery of the suction port 60a of the duct 60 and the second developing roller 31 on the right side, and respective quadrants of a coordinate plane on the left side. The right side diagram of FIG. 3 is a cross-section of the developing apparatus 1Y in which the second development region is positioned on the left side and the peeling magnetic field area is positioned on the right side, as illustrated in FIG. 2, and specifically, illustrates a case in which the second developing roller 31 is positioned on the left side of the peeling roller 32 in a cross-section orthogonal to the rotational axis of the second developing sleeve 34 in a state where the developing apparatus 1Y is attached to the image forming apparatus 100.

In this case, according to the present embodiment, in a first coordinate plane constituted of an x axis in a horizontal direction and a y axis in a vertical direction with the rotation center O of the second developing sleeve 34 set as the origin, a rotation center O’ of the peeling sleeve 35 is positioned in a first quadrant. Further, in a second coordinate plane constituted of the x axis in the horizontal direction and the y axis in the vertical direction with the rotation center O’ of the peeling sleeve 35 set as the origin, the suction port 60a of the duct 60 is positioned in a second quadrant.

Specifically, the duct 60 is arranged on an upper area within the developing apparatus 1Y, and the other end portion of the duct 60 is connected to the main duct extending from the image forming apparatus body, as described above. Further, the suction port 60a disposed on one end portion of the duct 60 is positioned inside the developing container 70. Inside the developing apparatus 1Y, the duct 60 extends approximately horizontally, and is bent in the direction of the second development region above the peeling roller 32. Further, the edge on the suction port 60a side of the first duct wall, inner guide, 61 is positioned in the vicinity between the peeling roller 32 and the second developing roller 31. Now, an edge of the first duct wall 61 of the duct 60 on the suction port 60a side, which is an end point on a second duct wall, i.e., outer guide, 62 side, is set as a reference point, i.e., first reference point, A. In this case, the reference point A is in the first quadrant of the first coordinate plane in which the rotation center O of the second developing sleeve 34 is set as the origin, and also in the second quadrant of the second coordinate plane in which the rotation center O’ of the peeling sleeve 35 is set as the origin.

### Magnetic Poles of Respective Magnets

Next, FIG. 4 illustrates magnetic pole arrangements of the first developing magnet 36, the second developing magnet 37, and the peeling magnet 38 included in the first developing roller 30, the second developing roller 31, and the peeling roller 32. The first developing magnet 36 within the first developing roller 30 has the plurality of magnetic poles 101 to 107. The S and N of the respective magnets illustrated in FIG. 4 indicate whether the magnetic pole is an S pole or an N pole, and the radial lines within the respective magnets indicate a maximum value position where the normal component of magnetic flux density is maximum in each magnetic pole. According to the present embodiment, the first developing magnet 36 includes a total of seven magnetic poles. Among the magnetic poles, the magnetic pole 106 is a delivery pole for delivering the developer from the first developing roller 30 to the second developing roller 31. The magnetic poles 101 to 107 are arranged in number order in the rotational direction of the first developing sleeve 33.

The magnetic pole 106 is a magnetic pole for delivering the developer from the first developing sleeve 33 to the second developing sleeve 34 by a magnetic field generated in cooperation with the second developing magnet 37 of the second developing roller 31, and hereinafter, may also be referred to as the delivery pole 106. The magnetic pole 107 is an N pole, and is used to attract the developer supplied from the developer supplying screw 42 onto the first developing sleeve 33. The magnetic poles 101, 102, 103, 104, and 105 are an S pole, an N pole, an S pole, an N pole, and an S pole, respectively, and are used to feed the developer attracted by the magnetic pole 107 upward as the first developing sleeve 33 rotates. The magnetic pole 106 is an N pole, and delivers the developer from the first developing sleeve 33 to the second developing sleeve 34 facing the first developing sleeve 33 by a magnetic field generated in cooperation with the magnetic pole 201 in the second developing magnet 37 within the second developing roller 31 as described above.

In the present embodiment, a low magnetic force portion 110 having a magnetic force lower than that of the magnetic pole 106 is formed by a repulsive magnetic field generated in cooperation between the magnetic pole 106 and the magnetic pole 107 disposed downstream of the magnetic pole 106 in the rotational direction of the first developing sleeve 33 and having the same magnetic polarity as the magnetic pole 106. The low magnetic force portion 110 promotes delivery of the developer from the first developing sleeve 33 to the second developing sleeve 34. Note that the low magnetic force portion 110 has almost no magnetic force in the present embodiment, but alternatively, may have a low magnetic force, and for example, may be a magnetic pole having a magnetic force, i.e., absolute value of a normal component Br of the magnetic flux density, of 10 mT or less, or even 5 mT or less. The same applies to a low magnetic force portion 210 of the second developing magnet 37 and a low magnetic force portion 310 of the peeling magnet 38.

The second developing magnet 37 inside the second developing roller 31 has the plurality of magnetic poles 201 to 207, that is, a total of seven magnetic poles. Among them, the magnetic pole 201 is a receiving pole for the second developing roller 31 to receive the developer from the first developing roller 30. The magnetic poles 201 to 207 are arranged in number order in the rotational direction of the second developing sleeve 34.

The magnetic pole 201 is a magnetic pole for attracting the developer from the first developing sleeve 33 to the second developing sleeve 34 by a magnetic field generated in cooperation with the magnetic pole 107 of the first developing magnet 36 of the first developing roller 30, and hereinafter, may be referred to as the receiving pole 201. The magnetic pole 207 is a magnetic pole for delivering the developer from the second developing sleeve 34 to the peeling sleeve 35 by a magnetic field generated in cooperation with the peeling magnet 38 of the peeling roller 32, and hereinafter, may be referred to as the delivery pole 207.

Further, the magnetic pole 201 is an S pole having a magnetic polarity different from that of the magnetic pole 106, and is used to attract the developer from the first developing sleeve 33 onto the second developing sleeve 34 as described above. The magnetic poles 202, 203, 204, 205, and 206 are an N pole, an S pole, an N pole, an S pole, and an N pole, respectively, and are used to feed the developer attracted by the magnetic pole 201 upward as the second developing sleeve 34 rotates. The magnetic pole 206 may also be referred to as the feeding pole 206, as described in detail below. The magnetic pole 207 serving as a delivery pole is an S pole, and delivers the developer having passed through a development region between the magnetic pole 203 and the photosensitive drum 28Y facing the magnetic pole 203 from the second developing sleeve 34 to the peeling sleeve 35 facing the second developing sleeve 34 by a magnetic field generated in cooperation with the magnetic pole 303 of the peeling magnet 38 within the peeling roller 32.

In the present embodiment, the low magnetic force portion 210 having a magnetic force lower than that of the magnetic pole 207 is formed by a repulsive magnetic field generated in cooperation between the magnetic pole 201 and the magnetic pole 207 disposed upstream of the magnetic pole 201 in the rotational direction of the second developing sleeve 34 and having the same magnetic polarity as the magnetic pole 201. The low magnetic force portion 210 promotes delivery of the developer from the first developing sleeve 33 to the second developing sleeve 34. In addition, the low magnetic force portion 210 can prevent the developer from being attracted to the closest portions of the first developing sleeve 33 and the second developing sleeve 34, such that a pressure applied to the developer can be suppressed.

The peeling magnet 38 inside the peeling roller 32 has the plurality of magnetic poles 301 to 305, that is, a total of five magnetic poles. The magnetic poles 301 to 305 are arranged in number order in the rotational direction of the peeling sleeve 35. The magnetic pole 303 serving as a receiving pole is a magnetic pole for attracting the developer from the second developing sleeve 34 to the peeling sleeve 35 by the magnetic field generated in cooperation with the magnetic pole 207 of the second developing magnet 37 of the second developing roller 31, and hereinafter, may be referred to as the receiving pole 303. The magnetic pole 303 is an N pole that is of different magnetic polarity as the magnetic pole 207, and is used to attract the developer peeled off from the second developing sleeve 34 to the peeling sleeve 35 as described above. The magnetic poles 301, 302, and 304 are an N pole, an S pole, and an S pole, respectively, and are used to feed the developer on the peeling sleeve 35 as the peeling sleeve 35 rotates. The magnetic pole 301 is an N pole, and is a peeling pole used to peel off the developer attracted to the peeling sleeve 35 from the peeling sleeve 35 by a repulsive magnetic field generated in cooperation with the magnetic pole 305 having the same magnetic polarity, and hereafter, it may also be referred to as the peeling pole 301. The low magnetic force portion 310 having a magnetic force lower than that of the magnetic pole 301 is formed between the magnetic pole 301 and the magnetic pole 305.

As described, the first developing magnet 36 and the second developing magnet 37 are each constituted of seven magnetic poles. The second developing sleeve 34 receives the developer at the receiving pole 201 facing the first developing sleeve 33, conveys the developer from down to up in the vertical direction, and develops the electrostatic latent image on the photosensitive drum 28Y using the toner by the magnetic pole, i.e., developing pole, 203 at the second development region. The developer having gone through the developing process is fed via a plurality of feeding poles, peeled off from the second developing roller 31 at the peeling magnetic field area formed by the delivery pole 207, and delivered to the peeling roller 32. Thereafter, the developer is collected in the developing container 70.

### Detachment of Carrier Particles

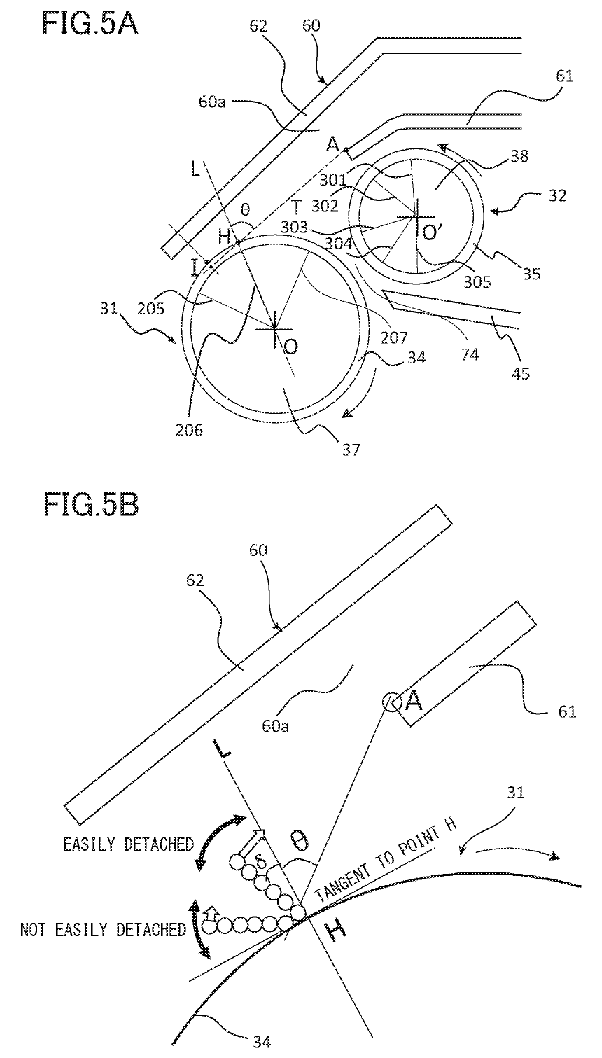

Next, a relationship between the position of the feeding pole 206 of the second developing magnet 37 positioned upstream in a suction direction of air by the duct 60 than the suction port 60a of the duct 60 and the duct 60 will be described. As illustrated in FIG. 5A, the duct 60 is disposed such that the suction port, i.e., opening portion, 60a faces the region between the second development region and the peeling magnetic field area. The feeding pole 206 of the second developing roller 31 is arranged at a position facing the suction port 60a of the duct 60.

When a point on the surface of the second developing sleeve 34 closest to the inner wall surface of the second duct wall 62 of duct 60 is referred to as point I, the feeding pole 206 is a magnetic pole positioned within a section from a point I to the delivery pole 207 with respect to the rotational direction of the second developing sleeve 34. Preferably, one magnetic pole is present in this section. If the length of the second duct wall 62 is short such that the inner wall surface of the second duct wall 62 does not face the surface of the second developing sleeve 34, the point I may be set at a closest position between the surface of the second developing sleeve 34 and a virtual surface having extended the edge of the second duct wall 62.

In the feeding pole 206, a line of magnetic force extends in the vertical direction with respect to the surface of the second developing magnet 37. When the developer is fed by the rotation of the second developing sleeve 34 and passes through the feeding pole 206, the carrier particles within the developer form a magnetic brush along the magnetic field formed by the feeding pole 206. The magnetic brush is formed in a circumferential direction along the surface of the second developing magnet 37 between the magnetic poles of the feeding pole 206 and the magnetic pole 205 upstream thereof.

Here, the position of maximum value of the normal component of magnetic flux density of the feeding pole 206 on the surface of the second developing sleeve 34 is referred to as a surface position H. The magnetic brush rises up gradually as it approaches the surface position H, and at the surface position H, the magnetic brush becomes vertical with respect to the surface of the second developing sleeve 34. Thereafter, the magnetic brush is conveyed while collapsing in the traveling direction while being conveyed toward the peeling magnetic field area. It is preferable for the surface position H to be positioned downstream of a vertical direction peak of the second developing sleeve 34 in the rotational direction of the second developing sleeve 34, that is, to be positioned in the first quadrant of the first coordinate plane (refer to FIG. 3) with the rotation center O of the second developing sleeve 34 set as origin.

Next, the scattering of carrier particles at the feeding pole 206 will be described. In the configuration of the present embodiment, a rotational direction force and a centrifugal force of the second developing sleeve 34 act on the carrier particles at the edge of the magnetic brush of the feeding pole 206, such that carrier particles at the edge of the magnetic brush are easily detached from the magnetic brush. Further, since the carrier particles at the edge of the magnetic brush are positioned farthest from the second developing magnet 37, magnetic restraining force becomes relatively weak, and the carrier particles are easily detached from the magnetic brush. The detached carrier particles are projected upward from an approximately tangential direction with the peripheral speed of the second developing sleeve 34 and the movement speed of the magnetic brush acting as an initial velocity. There is a variation in how easily the carrier particles are detached from the magnetic brush, depending, for example, on the particle size and variation of magnetic property of carrier particles, state of contact with adjacent particles in the magnetic brush, the length of the magnetic brush, and the distance from the surface of the second developing magnet 37. Therefore, if the carrier particles are detached from the magnetic brush, it is necessary to suppress the sucking of carrier particles into the duct 60.

The positional relationship between the feeding pole 206 and the duct 60 is of great importance for preventing carrier particles from scattering in the duct 60. The relationship between the reference point A of the duct 60 described above and the surface position H regarding the feeding pole 206 will be described. At first, in a case where a straight line passing the surface position H and the rotation center O of the second developing sleeve 34 is referred to as a straight line L, and a straight line passing the reference point A and the surface position H is referred to as a straight line T, the relationship between the straight line L and the straight line T indicates the relationship between the position where the magnetic brush of the feeding pole 206 becomes highest and the direction from this highest position toward the duct 60.

An angle formed by the straight line L and the straight line T on the reference point A side, that is, an angle formed by a line segment A-H of the straight line T between the reference point A and the surface position H and a portion opposite to the rotation center O of the straight line L with respect to the surface position H, i.e., acute angle, is referred to as θ. In this state, at θ = 90°, the suction port 60a of the duct 60 is positioned in the conveyance direction of the magnetic brush of the feeding pole 206. As illustrated in FIG. 5B, at the surface position H of the second developing roller 31 regarding the feeding pole 206, the normal component of a magnetic flux density Br becomes greatest and the magnetic brush rises highest in the vertical direction. Further, at the surface position H of the second developing roller 31 regarding the feeding pole 206, the amount of variation of an angular velocity ω becomes zero and the angular velocity ω becomes maximum. The speed of the magnetic brush on the second developing sleeve 34 in the tangential direction with respect to the outer surface of the second developing sleeve 34 and centrifugal force acting on the magnetic brush becomes maximum in this state. Meanwhile, when the magnetic brush rises, the edge of the magnetic brush is positioned far from the second developing magnet 37, such that the magnetic restraining force is weakened. In this state, the carrier particles are detached from the edge of the magnetic brush at a timing at which a centrifugal force mrω² exceeds a magnetic force Fr between carrier particles.

That is, when mrω² > Fr is satisfied, the carrier particles being detached are projected in the approximately vertical direction with respect to the magnetic brush from the tangential direction of the second developing sleeve 34. Based on the above, at the feeding pole 206, the carrier particles are most easily detached from when the magnetic brush rises up until it reaches the peak, and that the carrier particles tend to travel toward the duct 60. In this state, if the carrier particles at the edge of the magnetic brush are detached at the feeding pole 206, the carrier particles will fly toward the duct 60 and is carried by the air flow in the duct 60 to the main duct to be collected by the filter inside the image forming apparatus.

Meanwhile, in a state where the magnetic brush exceeds the position of the surface position H of the feeding pole 206 and reaches an angle where the magnetic brush starts to incline downstream in the rotational direction of the second developing sleeve 34, even if carrier particles are detached from the edge of the magnetic brush, the carrier particles will be projected toward the surface of the second developing sleeve 34, such that they will be collected by the second developing magnet 37.

Therefore, according to the present embodiment, by optimizing the flying direction of the carrier particles at the surface position H, where the centrifugal force mrω² becomes maximum, of the second developing roller 31 regarding the feeding pole 206, and the position of the suction port 60a of the duct 60, the filter clogging of the image forming apparatus body can be reduced. Specifically, the present embodiment proposes a configuration in which the amount of carrier particles being carried by the airflow into the duct 60 may be reduced by setting the surface position H, the reference point A, the straight line L, and the straight line T as described above.

### Regarding angle θ

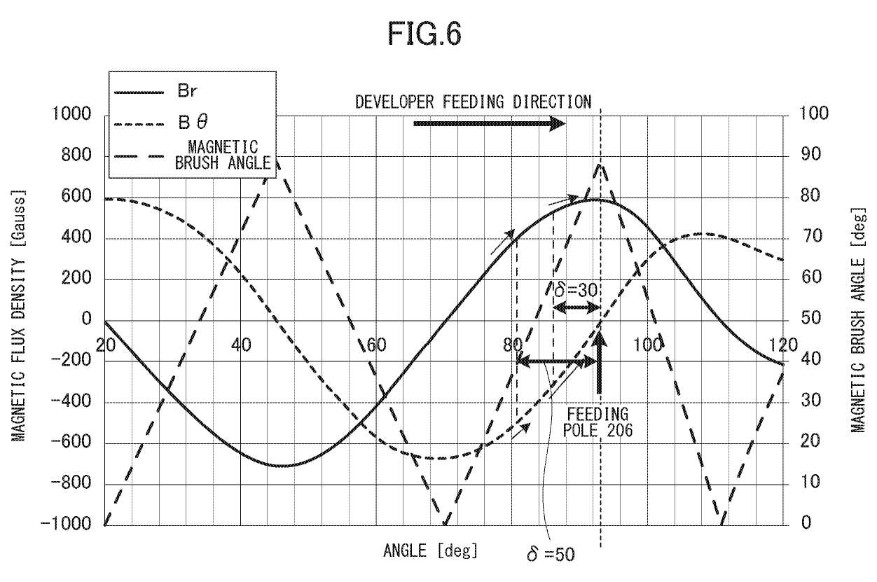

FIG. 6 illustrates a relationship between the normal component Br of magnetic flux density in the vicinity of the feeding pole 206 on the surface of the second developing sleeve 34, a tangential component Bθ of magnetic flux density, and the angle of line of magnetic force as the magnetic brush angle. A horizontal axis of FIG. 6 indicates an angle in a state where a point where a line connecting the rotation center O of the second developing sleeve 34 and the rotation center of the photosensitive drum 28Y crosses the surface of the second developing sleeve 34 is set as 0°, and the clockwise direction of FIG. 4, i.e., rotational direction of the second developing roller 31, is set as positive. Further, the angle of the magnetic brush is the angle of the magnetic brush with respect to the tangential direction of the surface of the second developing sleeve 34.

The magnetic brush angle at 90° is vertical with respect to the surface of the second developing sleeve 34. In this state, the normal component Br of the magnetic flux density is approximately at the peak, whereas the amount of variation of the tangential component Bθ of the magnetic flux density is increased, and the carrier particles at the edge of the magnetic brush is accelerated further in the circumferential direction toward Bθ = 0. In this state, the angle of the magnetic brush from a perpendicular line with respect to the tangential line on the surface of the second developing sleeve 34 is referred to as δ. Further, the angle δ is set such that the direction in which the edge of the magnetic brush collapses in an opposite direction as the rotational direction of the second developing sleeve 34 is set as positive. That is, the angle δ is the angle of the range in which the magnetic brush rises. FIG. 5B illustrates the angle δ of the magnetic brush with respect to a perpendicular line, i.e., the straight line L, with respect to the tangential line on the surface of the second developing sleeve 34 at the surface position H. Based on the angle δ and the angle θ described above, when δ + θ is 90°, the direction in which the carrier flies from the edge of the magnetic brush is the direction of the duct 60.

In FIG. 6, the magnetic brush angle in which the amount of variation of Bθ becomes great is approximately within the range of 60° to 90°. That is, as illustrated in FIG. 5B, the carrier particles at the edge of the magnetic brush of the feeding pole 206 are easily detached from the magnetic brush. When the magnetic brush angle is approximately 60°, δ ≈ 30° is satisfied, such that by setting θ ≤ 60°, δ + θ will be approximately smaller than 90°, and the flying direction of the carrier may be set downward with respect to the direction toward the duct 60. Therefore, by setting angle θ ≤ 60°, the carrier particles detached from the magnetic brush of the feeding pole 206 and projected upward may be suppressed from flying upward in the vertical direction than the reference point A of the suction port 60a of the duct 60, and thereby, the clogging of the filter by carrier particles may be reduced.

Similarly, in FIG. 6, the amount of variation of Bθ becomes great and the acceleration with respect to the carrier particles at the edge of the magnetic brush becomes maximum near δ ≈ 50°, such that in this case, by setting angle θ to θ ≤ 40°, the scattering of carrier particles toward the direction of the suction port 60a of the duct 60 may be suppressed.

### Example 1

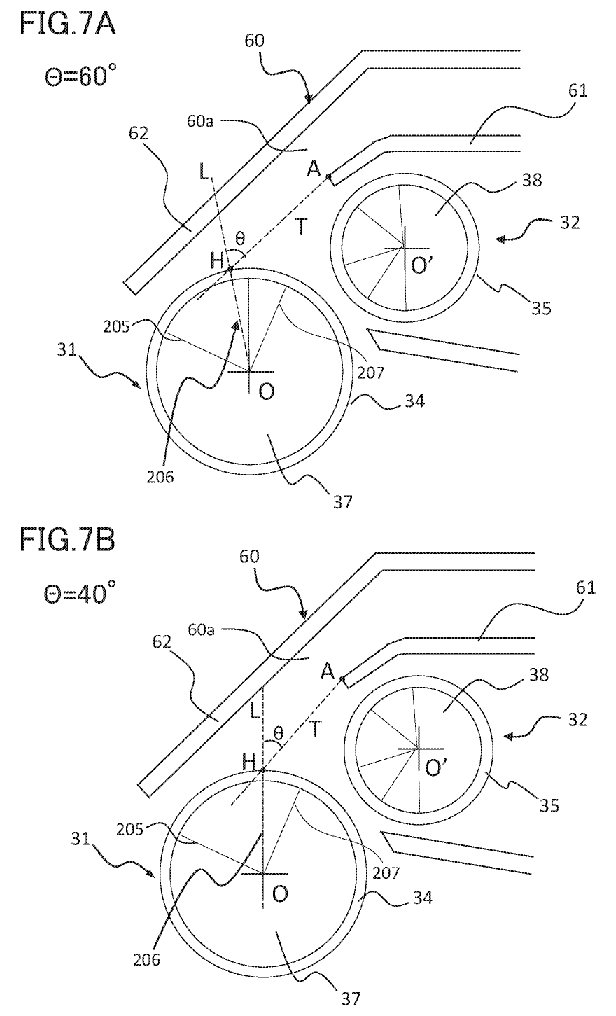

FIGS. 7A and 7B illustrate configurations of magnetic poles in which the angle θ is respectively set to 60° and 40°, as Example 1. FIGS. 7A and 7B illustrate a similar view as FIG. 5A, wherein θ = 60° in FIG. 7A and θ = 40° in FIG. 7B. An experiment examining the level of carrier collection was carried out for configurations in which the angle θ is set to 60° and 40°, and in addition, in which the angle is set to 75°, 45°, and 35°, respectively. In this experiment, the level of carrier collection of each configuration was examined using the developing apparatus having the respective configurations, but the duct 60 was not connected to the main duct as described above, and instead, the carrier particles conveyed by airflow to the exterior of the developing apparatus were collected using a magnet. That is, the present experiment did not examine the amount of clogging of the filter, but instead, examined the amount of collection of the carrier particles that has been sucked into the duct 60 and collected by a magnet that has been disposed as a separate member as the developing apparatus. If the amount of carrier particles collected by the magnet is great, it means that the cogging of the filter easily occurs.

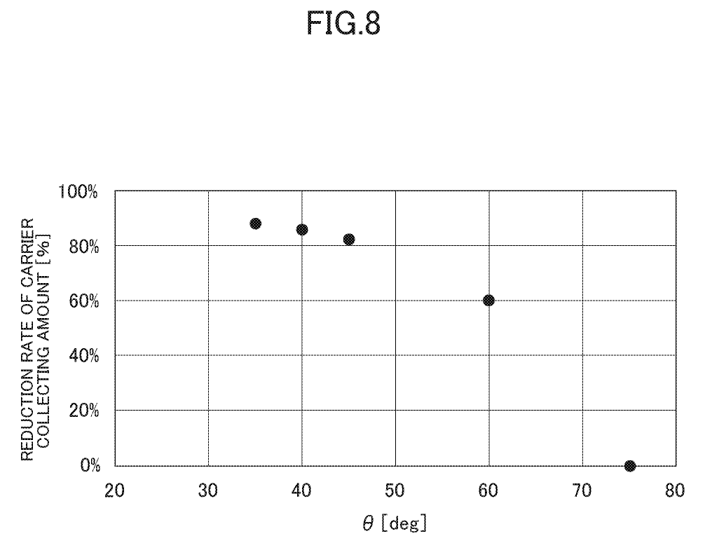

FIG. 8 illustrates the results of the above-described experiment. FIG. 8 sets the amount of collection of carrier particles at θ = 75° as a reference, and illustrates the reduction rate with respect to the amount of collection at this time. At θ = 75°, a relatively large amount of carrier particles were sucked into the duct 60 and collected, and by setting θ to a smaller value, the amount of collection was reduced. At θ = 60°, the amount was reduced by approximately 60%, and at θ = 40°, the amount was reduced by approximately 80% or more.

The amount of carrier collection could be reduced greatly by setting θ ≤ 40°, since, as described above, the tangential direction of the second developing sleeve 34 at the surface position H is oriented downward with respect to the reference point A of the duct 60, and the carrier particles projected upward from the magnetic brush of the feeding pole 206 fly toward the direction of the peeling roller 32.

Meanwhile, when the angle is set to θ ≤ 30°, the feeding pole 206 is positioned close to the delivery pole 207 disposed downstream in the rotational direction of the second developing sleeve 34 and to the receiving pole 303 of the peeling roller 32, such that a repulsive magnetic field is easily generated between magnetic poles, and delivery of developer from the second developing roller 31 to the peeling roller 32 is obstructed. Specifically, at θ ≤ 30°, the accuracy of delivery of the developer was deteriorated, and corotation of some amount of developer on the second developing sleeve 34 occurred. Therefore, it is preferable that θ > 30° is satisfied.

As described, according to the present embodiment, θ ≤ 60° is satisfied, such that even if carrier particles were detached from the magnetic brush on the feeding pole 206, the carrier particles fly toward the peeling roller 32 rather than toward the suction port 60a of the duct 60. Therefore, the collection of carrier particles into the duct 60 may be suppressed. Further, by satisfying θ ≤ 40°, the collection of carrier particles into the duct 60 may be suppressed even further.

According to the present embodiment, the shape of the first duct wall 61 and the position of the reference point A was fixed and the position of the feeding pole 206 was changed to verify the suction of carrier particles, but as long as the position of the reference point A is in the quadrant position described above, a similar case as that verified above may be realized.

### Second Embodiment

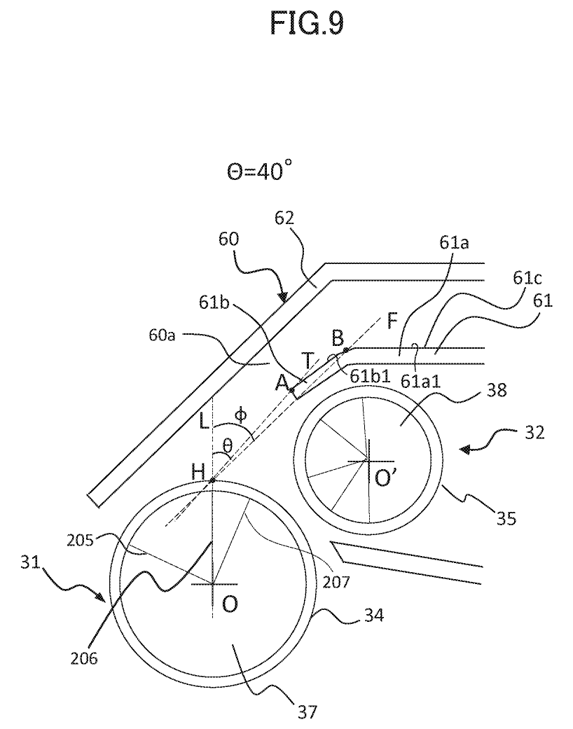

A second embodiment will be described with reference to FIGS. 9 to 12. According to the present embodiment, a configuration capable of further suppressing carrier particles from being collected by the duct 60 by newly setting a second reference point B regarding the duct 60 is described. Further according to the present embodiment, a configuration in which the shape of the first duct wall 61 of the duct 60 differs from the first embodiment will be described. The other configurations and effects are similar to those described above with respect to the first embodiment, such that the same components are denoted with the same reference numbers and descriptions thereof are omitted or simplified, and the points that differ from the first embodiment will mainly be described below.

As illustrated in FIG. 9, in the cross-section orthogonal to the rotational axis of the second developing sleeve 34, the reference point A is referred to as a first reference point A, and a point on an inner wall surface 61c, which is the wall surface on the second duct wall 62 side of the first duct wall 61, which is a point positioned on the side in which the duct 60 extends from the first reference point A, is referred to as the second reference point B. In this case, the second reference point B is a point where a first surface 61b1 of the inner wall surface 61c extending to the first reference point A from the second reference point B is inclined with respect to a second surface 61a1 of the inner wall surface 61c positioned on the opposite side of the second reference point B from the first reference point A. That is, the second reference point B is a portion where the first duct wall 61 bends, specifically, a point on the inner wall surface 61c where the first wall portion 61a and a second wall portion 61b connect. Therefore, the first surface 61b1 is the wall surface of the second wall portion 61b on the second duct wall 62 side, and the second surface 61a1 is the wall surface of the first wall portion 61a on the second duct wall 62 side.

In the present embodiment, the second reference point B is a part of the first duct wall 61, and it is a point positioned above the peeling roller 32 where the first duct wall 61 changes its direction toward the second development region. In a case where there are multiple points where the direction changes, the uppermost point in the vertical direction is set as the second reference point B. The second reference point B is positioned in the first quadrant of the first coordinate plane where the rotation center O of the second developing sleeve 34 is set as origin, and in the first quadrant or the second quadrant of the second coordinate plane where the rotation center O’ of the peeling sleeve 35 is set as origin, as illustrated in FIG. 3.

According to FIG. 9 and the first embodiment, the second duct wall 62 and the first duct wall 61 are each arranged linearly within the range from the second reference point B to the first reference point A. As described in the first embodiment, when the carrier particles fly from the magnetic brush of the feeding pole 206 and passes the position of the first reference point A on the first duct wall 61 of the duct 60, the carrier particles are easily conveyed by airflow toward the depth side of the duct 60. Further, if carrier particles fall into an inclined portion, that is, the first surface 61b1, between the first reference point A and the second reference point B, the carrier particles having fallen may move on the first duct wall 61 and drop onto the second developing roller 31 by vibration of the developing apparatus 1Y.

Meanwhile, if the carrier particles sucked into the duct 60 move beyond the second reference point B, the carrier particles will be accumulated in the duct 60 or on the filter without returning to the second developing roller 31, i.e., to the developing apparatus 1. Therefore, the angles and shapes of a potion between the first reference point A and the second reference point B of the first duct wall 61 are also factors that influence the amount of suction of carrier particles.

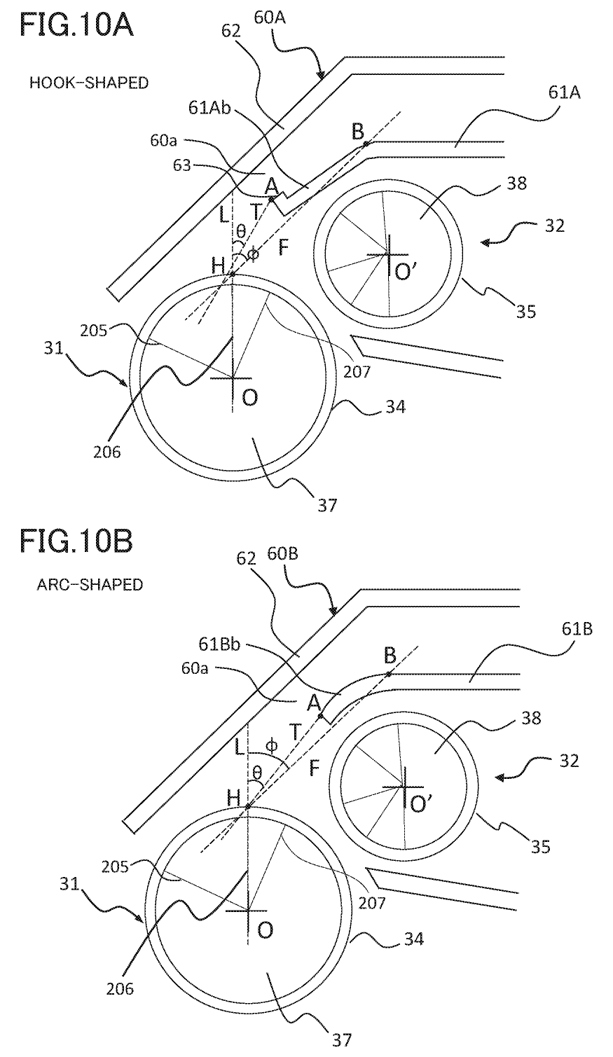

The shape of the first duct wall 61 between the first reference point A and the second reference point B, i.e., the shape of the second wall portion 61b, is not limited to a linear shape. For example, it may be a hooked shape as illustrated in FIG. 10A, or may be an arc shape as illustrated in FIG. 10B. In a duct 60A illustrated in FIG. 10A, a projection 63 that protrudes upward is formed at an end portion on the suction port 60a side of a second wall portion 61Ab of a first duct wall 61A, and an end portion of the projection 63 is referred to as the first reference point A. In this state, a point of a corner of the projection 63 closest to the second duct wall 62 is referred to as the first reference point A. Further, in a duct 60B illustrated in FIG. 10B, a second wall portion 61Bb of a first duct wall 61B is arc-shaped that is curved to protrude toward the second duct wall 62. In this case, a position where the curvature changes is set as the second reference point B. In a case where there are a plurality of points where the curvature changes, the uppermost point in the vertical direction is referred to as the second reference point B.

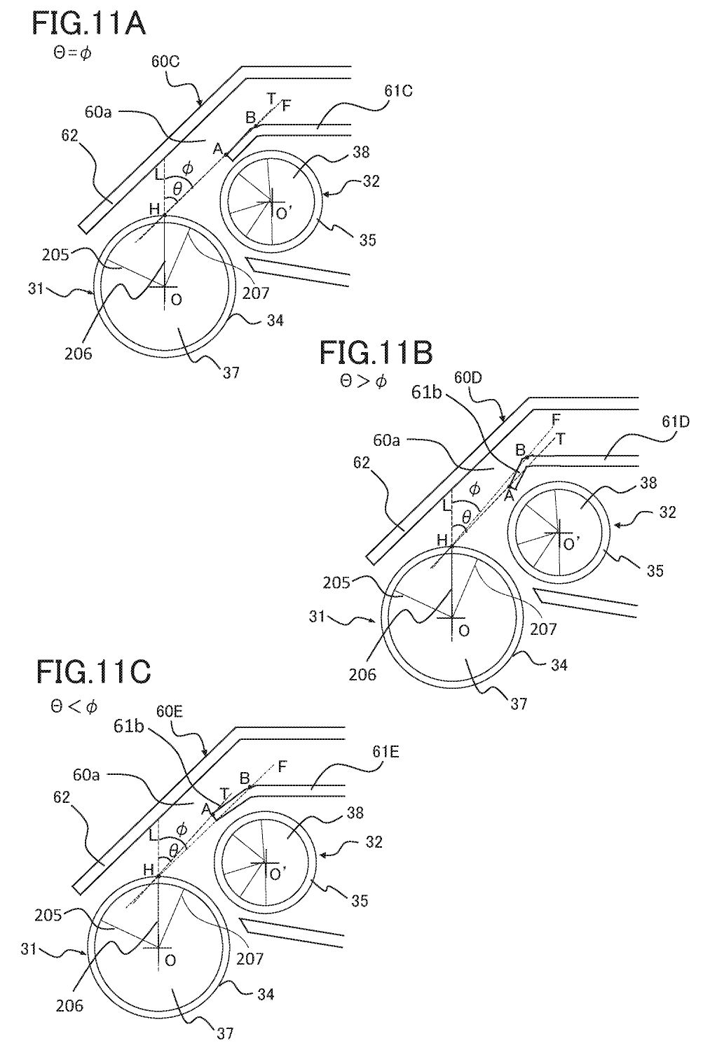

In this case, a straight line passing the second reference point B and the surface position H is referred to as a straight line F. Further, an angle, i.e., acute angle, formed by a line segment B-H between the second reference point B and the surface position H of the straight line F and a portion of the straight line L opposite to the rotation center O with respect to the surface position H is referred to as φ. In this case, in a duct 60C as illustrated in FIG. 11A, regarding a first duct wall 61C having a configuration in which the straight line F and the straight line T overlap, φ = θ is satisfied. Further, in a duct 60D as illustrated in FIG. 11B, at φ < θ, an inclination of an interposed portion, i.e., the second wall portion 61b, between the first reference point A and the second reference point B of a first duct wall 61D will be steep. That is, compared to the case where θ = φ, the angle of the second wall portion 61b from the horizontal direction is increased. Further, at φ > θ, as according to a duct 60E illustrated in FIG. 11C, the inclination of the interposed portion, i.e., the second wall portion 61b, between the first reference point A and the second reference point B of the first duct wall 61E becomes gentle. That is, the angle of the second wall portion 61b with respect to the horizontal direction becomes smaller compared to the case where θ = φ.

In this case, either one of φ and θ is set to satisfy the angle described in the first embodiment. That is, either θ ≤ 60° or φ ≤ 60° is satisfied. Further, preferably, either θ ≤ 40° or φ ≤ 40° is satisfied. More preferably, both φ and θ are set to satisfy the above-mentioned angles. That is, both θ ≤ 60° and φ ≤ 60° are satisfied. Preferably, both θ ≤ 40° and φ ≤ 40° are satisfied. Regarding φ, it is preferable that φ > 30° is satisfied.

### Example 2

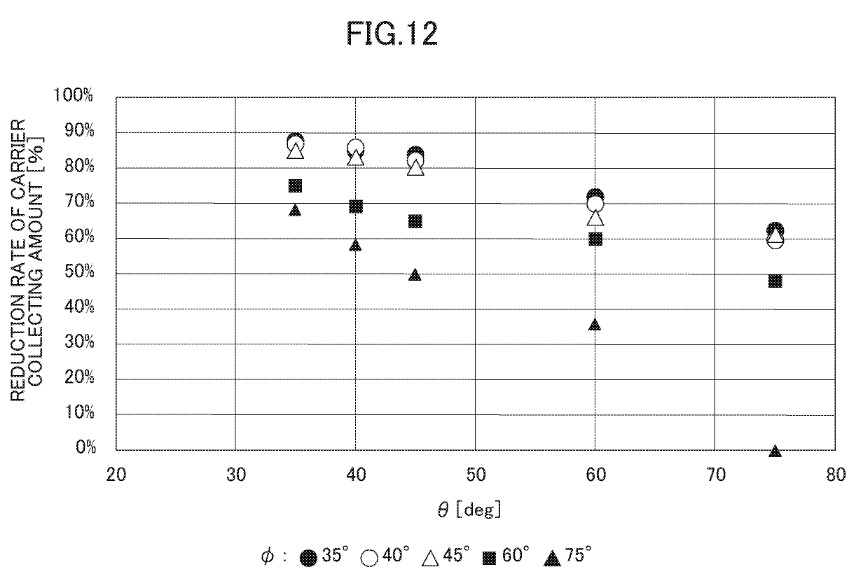

Example 2 illustrates an experiment in which a level of carrier collection has been examined for each of a configuration in which the angle θ and the angle φ are respectively set to 75°, 60°, 45°, 40°, and 35°, similar to Example 1. FIG. 12 illustrates the results of this experiment. In FIG. 12, similar to Example 1, a comparison of the amount of collection with the reference set to θ = 75° and φ = 75° is illustrated. That is, FIG. 12 illustrates a reduction rate with respect to the amount of collection of carrier particles, with the amount of collection of carrier particles of a case where θ = 75° and φ = 75° is set as reference. The horizontal axis of FIG. 12 represents angle θ. As for angle φ, different symbols are plotted in the graph of FIG. 12. The relationship between the numerical values of φ and the symbols are shown in FIG. 12.

Based on FIG. 12, it can be recognized that if either φ or θ is equal to a predetermined angle or smaller, that is, approximately 60° or smaller, the effect of reducing the suction amount of carrier particles can be realized, similar to the experiment of Example 1 illustrated in FIG. 8. As a tendency, the level of carrier collection was improved with respect to the evaluation of experiment of FIG. 8 when the angles of both φ and θ were small. Meanwhile, the effect of reducing the suction amount of carrier particles was somewhat greater by setting the angle θ regarding the first reference point A near the edge of the duct 60 small compared to setting the angle φ regarding the second reference point B small. Further, depending on the size of φ, carrier particles having reached the first duct wall 61 were conveyed by airflow to the depth side of the duct 60.

Based on the above description, it is considered preferable for both θ and φ to be set to 60° or smaller, and in order to achieve a better effect of reduction of suction amount of carrier particles, a configuration of θ < φ is preferable.

According to the present embodiment, even if the shape of the duct, such as the ducts 60A to 60E, is more complex than the shape of the duct according to the first embodiment, a configuration where the suction of carrier particles may be reduced is proposed, and the developing apparatus 1Y having a higher quality may be provided.

### Third Embodiment

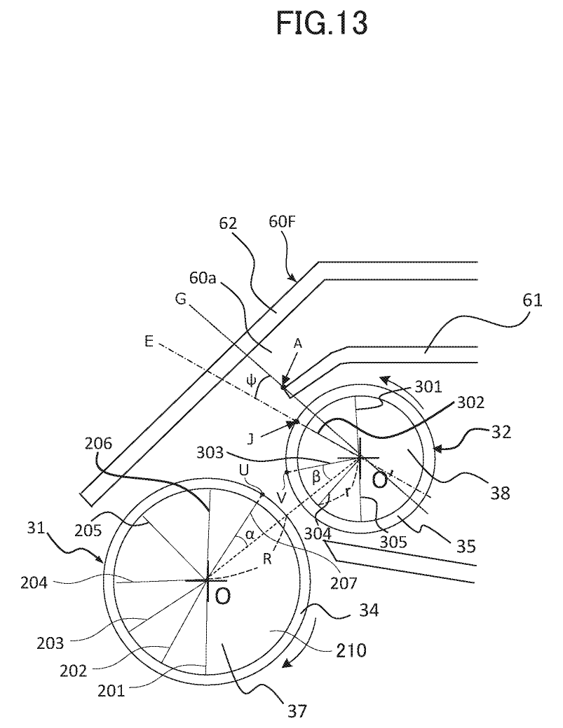

The third embodiment will be described with reference to FIGS. 13 to 17. The present embodiment describes a configuration in which scattering of carrier particles caused by a magnetic field formed by feeding poles 206 and 302 may be suppressed by appropriately setting a position of a feeding pole, i.e., first feeding pole, 206 of the second developing magnet 37 and a position of a feeding pole, i.e., second feeding pole, 302 of the peeling magnet 38 with respect to a duct 60F. The other configurations and effects are similar to those of the first embodiment, such that the same components are denoted with the same reference numbers and descriptions thereof are omitted or simplified, and the points that differ from the first embodiment will mainly be described below.

The present embodiment is described based on a configuration where the relationship between the feeding pole 206 of the second developing magnet 37 and the reference point A is θ = 40°, as illustrated in the first embodiment described above. Further according to the present embodiment, a configuration of θ < φ is adopted. As illustrated in FIG. 13, the feeding pole 302 is one of a plurality of magnetic poles positioned upstream of the closest portion of the second developing roller 31 and the peeling roller 32 in the rotational direction of the peeling sleeve 35. Further, the feeding pole 206 and the feeding pole 302 have mutually different magnetic polarities.

As have been described with reference to the first embodiment, by setting the angle θ to 60° or smaller, the carrier particles projected from the magnetic brush of the feeding pole 206 are directed toward an area below the duct 60, that is, toward the peeling roller 32. Therefore, when the carrier particles are projected from the edge of the magnetic brush in the feeding pole 206, in addition to the momentum caused by initial velocity, gravitational force, the magnetic field formed between the feeding pole 206 and the feeding pole 302, and the force by airflow in the duct 60F act on the carrier particles. The flying carrier particles are mainly influenced by the airflow from the duct 60F, and the direction in which the carrier particles fly is modified by the magnetic field from the feeding pole 206 toward the feeding pole 302.

In this state, the height of the reference point A of the first duct wall 61 may be set to such a height that the first duct wall 61 does not obstruct a trajectory in which the carrier particles fly to the peeling roller 32. Specifically, the reference point A is set to a position such that the first duct wall 61 of the duct 60F does not intersect the lines of magnetic force formed between the feeding pole 206 and the feeding pole 302 and to a position not opposing to the feeding pole 206 and the feeding pole 302. If the first duct wall 61 of the duct 60F is arranged to intersect the lines of magnetic force from the feeding pole 206 toward the feeding pole 302, the carrier particles flying from the feeding pole 206 will easily fly onto the first duct wall 61. Thereby, a configuration that causes carrier particles to be easily sucked into the duct 60F by airflow of the duct 60F is formed.

In this example, a position of maximum value of the normal component of magnetic flux density of the feeding pole 302 on the surface of the peeling sleeve 35 in a cross section orthogonal to the rotational axis of the second developing sleeve 34 is referred to as a surface position J. Further, a straight line passing the surface position J and the rotation center O’ of the peeling sleeve 35 is referred to as a straight line E, and a straight line passing the reference point A and the rotation center O’ is referred to as a straight line G. Further, when the rotational direction of the peeling sleeve 35 is referred to as positive, an angle from a line segment A-O’ of the straight line G between the reference point A and the rotation center O’ to a line segment J-O’ of the straight line E between the surface position J and the rotation center O’ is referred to as ψ. In this case, in order for the first duct wall 61 not to intersect the lines of magnetic force from the feeding pole 206 toward the feeding pole 302, ψ > 0 is preferably satisfied.

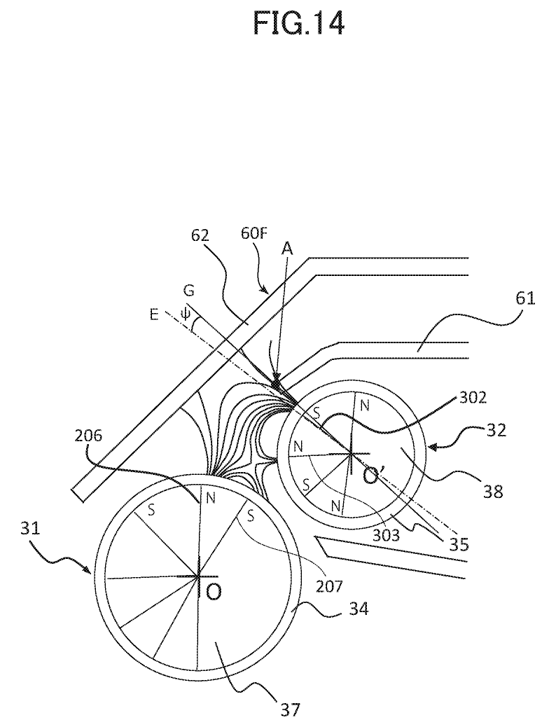

Regarding the configuration of the present embodiment, a distribution of lines of magnetic force between the feeding pole 206 of the second developing magnet 37 and the feeding pole 302 of the peeling magnet 38 in a state where θ = 40° and ψ = 5° is illustrated in FIG. 14. The feeding pole 302 is positioned at a position approximately facing the reference point A. In this state, as described above, the first duct wall 61 interferes with a portion of the lines of magnetic force from the feeding pole 206 to the feeding pole 302.

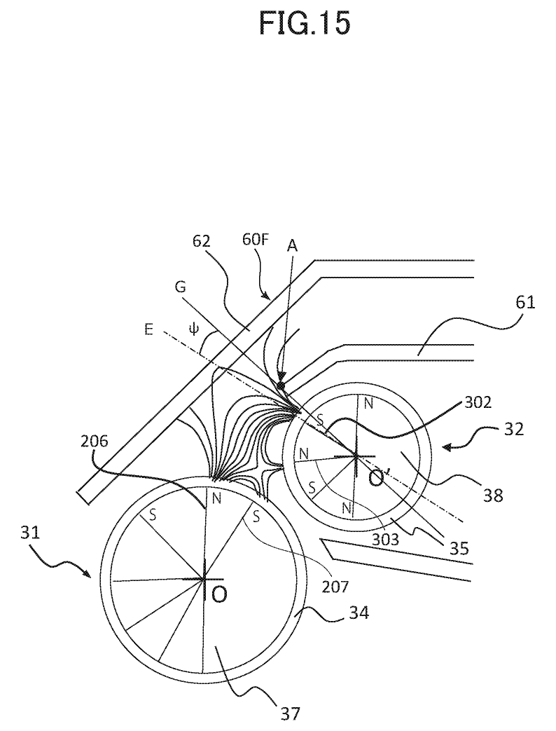

Meanwhile, as a configuration of the present embodiment, a distribution of lines of magnetic force between the feeding pole 206 and the feeding pole 302 in a state where θ = 40° and ψ = 10° is illustrated in FIG. 15. In this state, the lines of magnetic force extending from the feeding pole 206 to the feeding pole 302 are distributed regardless of the first duct wall, and the risk of flying carrier particles being assisted by magnetic force to move toward the duct 60F can be reduced.

In contrast, if the position of the reference point A is lower than the straight line E, or if the position of the feeding pole 302 is arranged upstream of the straight line G in the rotational direction of the peeling sleeve 35, ψ < 0° is satisfied, and the lines of magnetic force extending from the feeding pole 206 toward the feeding pole 302 will be blocked by the first duct wall 61. Therefore, the carrier particles are easily sucked into the duct 60F.

Next, the positional relationship between the delivery pole 207 and the receiving pole 303 that are respectively positioned adjacent to the feeding pole 206 and the feeding pole 302 downstream of the rotational direction of the respective sleeves is not faced with each other at a nip portion between the second developing roller 31 and the peeling roller 32. In this state, the delivery pole 207 and the receiving pole 303 have mutually different magnetic polarities, and it is preferable that the receiving pole 303 is positioned downstream of the delivery pole 207 in the rotational direction of the peeling sleeve 35 in the nip portion. If the delivery pole 207 and the receiving pole 303 are positioned to face each other, the magnetic restraining force between magnetic poles is increased and the degradation of developer during delivery of developer may be promoted.

Therefore, the term “facing” described above is defined as follows. As illustrated in FIG. 13, at first, a maximum value position of normal component of the magnetic flux density of the delivery pole 207 at the surface of the second developing sleeve 34 is referred to as a surface position U, and a maximum value position of normal component of the magnetic flux density of the receiving pole 303 at the surface of the peeling sleeve 35 is referred to as a surface position V. Further, an angle formed by a straight line O-O’ passing the rotation center O of the second developing sleeve 34 and the rotation center O’ of the peeling sleeve 35 and a line segment U-O that connects the surface position U and the rotation center O of the second developing sleeve 34 is referred to as α. Further, an angle formed by the straight line O-O’ and a line segment V-O’ connecting the surface position V and the rotation center O’ of the peeling sleeve 35 is referred to as β. Further, a radius of the second developing sleeve 34 is referred to as R, and a radius of the peeling roller 32 is referred to as r. In this case, the term “facing” described above refers to a state where a relationship of Rsinα ≈ rsinβ is satisfied. The configuration of FIG. 13 referred to for description is set to α = 19° and β = 27°. Therefore, in order to satisfy the definition of “facing” described above, the angle of β is made small, i.e., the surface position V is displaced downstream in the rotational direction of the peeling sleeve 35.

Further, it is preferable for the surface position U to be positioned upstream of a point where the straight line O-O’ intersects the surface of the second developing sleeve 34 with respect to the rotational direction of the second developing sleeve 34, and for 5° ≤ α ≤ 30° to be satisfied. Even more preferably, the surface position U is positioned within the range of 10° ≤ α ≤ 20°. It is preferable for the surface position V to be positioned upstream of a point where the straight line O-O’ intersects the surface of the peeling sleeve 35 with respect to the rotational direction of the peeling sleeve 35, and for 5° ≤ β ≤ 30° to be satisfied. Even more preferably, the surface position V is positioned within the range of 10° ≤ β ≤ 20°.

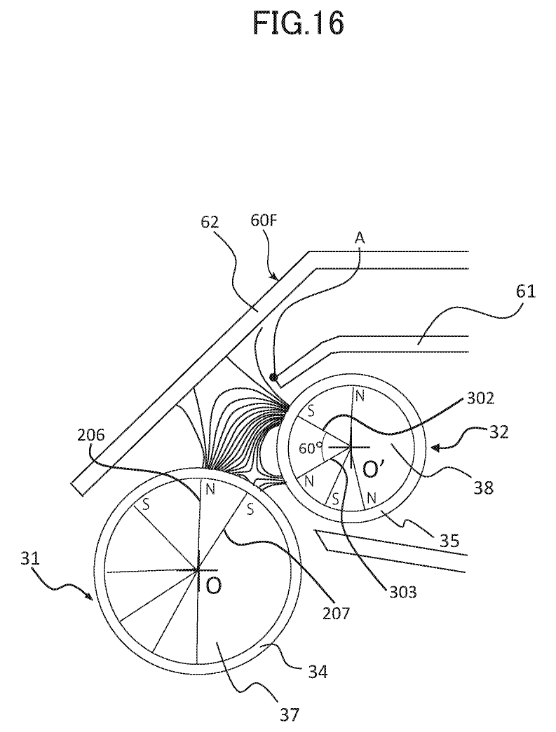

FIG. 16 illustrates a magnetic line distribution between the feeding pole 206 and the feeding pole 302 in a state where θ = 40°, ψ = 10°, α = 18°, and β = 7°. In the present configuration, the magnetic pole arrangement of the peeling magnet 38 is changed with respect to the configuration illustrated in FIG. 13, and the magnetic poles subsequent to the receiving pole 303 downstream of the feeding pole 302 with respect to the rotational direction of the peeling sleeve 35 are moved downstream. Specifically, according to the first and second embodiments, the angle between magnetic poles of the feeding pole 302 and the receiving pole 303 is 52°, whereas according to FIG. 16, the angle between the magnetic poles is 60°.

Thereby, according to the configuration illustrated in FIG. 16, it can be recognized that the phases of the delivery pole 207 and the receiving pole 303 are shifted and the lines of magnetic force are extended in the circumferential direction. Therefore, it becomes possible to deliver the developer efficiently while suppressing the degradation of the developer. Based on the above description, the relationship between the delivery pole 207 and the receiving pole 303 preferably satisfies α < β in which the lines of magnetic force are oriented toward the direction in which the developer flows.

### Example 3

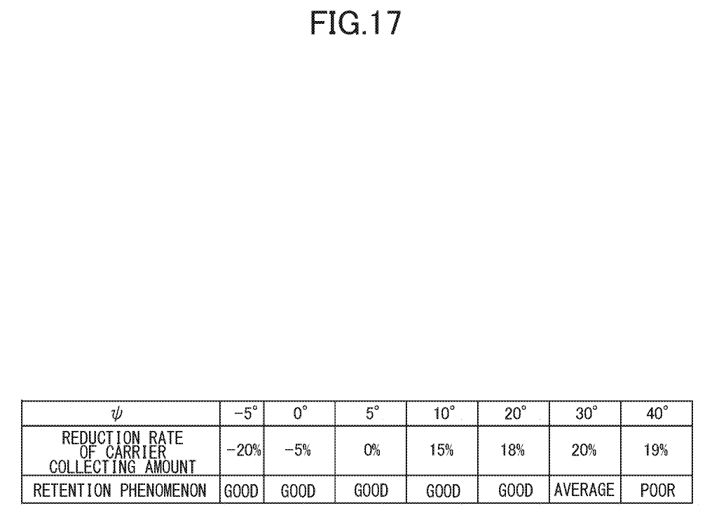

As an Example 3, an experiment having examined a level of carrier collection when an angle ψ is varied is illustrated. FIG. 17 illustrates a result of this experiment. Similar to Example 1, FIG. 17 illustrates a reduction rate with respect to the amount of collection of carrier particles, with the amount of collection of a case where ψ = 5° is set as reference. In this experiment, evaluation was performed based on whether the lines of magnetic force from the feeding pole 206 to the feeding pole 302 intersect the first duct wall 61, and the level of collection of carrier particles. The position of the feeding pole 302 of the peeling magnet 38 is set such that ψ is within the range of -5° to 40° with the position facing the reference point A set as reference.

As described above, at angle ψ ≥ 5°, the lines of magnetic force do not intersect the first duct wall 61, the amount of collection of carrier particles is reduced, whereas at ψ ≥ 10°, the level of collection is stably high, and is more preferable. Meanwhile, at ψ = 40°, the feeding pole 302 is positioned close to the delivery pole 207 of the second developing magnet 37. The feeding pole 302 and the delivery pole 207 are of the same polarity, such that the repulsive field is increased, the delivery property of developer from the second developing roller 31 to the peeling roller 32 is deteriorated, and retention occurred between the second developing roller 31 and the peeling roller 32. When retention occurs, toner may melt and attach to the roller surface, or degradation of developer may occur. In FIG. 17, “poor” indicates that retention has occurred between the second developing roller 31 and the peeling roller 32, “average” indicates that some retention has occurred but was not a problem, and “good” indicates that retention scarcely occurred.

Therefore, ψ ≥ 5° is preferable, and ψ ≥ 10° is even more preferable. Further, based on FIG. 17, ψ ≤ 30° is preferable, and ψ ≤ 20° is even more preferable. That is, the position of the feeding pole 302 is preferably within the range of 5° ≤ ψ ≤ 30° with respect to the reference point A, and is even more preferable to be within the range of 10° ≤ ψ ≤ 20°.

When setting ψ, it may be possible to set ψ to be within the above-described range by changing the position of the reference point A, or it may be possible to set ψ to be within the above-described range by rotating the peeling magnet 38 from a position illustrated in the first and second embodiments to the rotational direction of the peeling sleeve 35. Further, it may be possible to set ψ to be within the above-described range by changing the position of the feeding pole 302 and the magnetic pole adjacent thereto.

As described, even according to the configuration of the present embodiment, the suction of carrier particles by the duct 60F may be suppressed effectively, and a high-quality developing apparatus may be provided.

### Other Embodiments

The respective embodiments were described based on a developing apparatus including two developing rollers, but the present disclosure is also applicable to a configuration in which only one developing roller is provided. That is, the present disclosure is applicable to a configuration in which there is one developing roller for developing the electrostatic latent image on an image developing member, such as a photosensitive drum, and in which a peeling roller for peeling the developer from the developing roller is provided.

The present invention is not limited to the configuration of the respective embodiments described above. For example, the image forming apparatus 100 is not limited to the MFP, and may be a copier, a printer, or a facsimile machine. Further, the configurations of the developer supplying screw 42, the developer stirring screw 43, and the developer collecting screw 44 are not particularly limited as long as the developer can be fed, and for example, a spiral blade or a paddle blade can be applied.

According to the present disclosure, collection of carrier by the duct portion can be suppressed.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-202211, filed November 20, 2024, which is hereby incorporated by reference herein in its entirety.

What is claimed is:

1. A developing apparatus comprising:
a developing container including a first chamber configured to contain a developer including a toner and a carrier, and a second chamber partitioned from the first chamber by a partition wall;
a first rotatable member to which the developer is supplied, the first rotatable member being configured to carry and feed the developer to a developing position where an electrostatic latent image formed on an image bearing member is developed;
a first magnet provided non-rotatably and stationarily inside the first rotatable member, the first magnet having a first magnetic pole provided to face the image bearing member at the developing position, a second magnetic pole provided downstream of the first magnetic pole with respect to a rotational direction of the first rotatable member, a third magnetic pole provided downstream of the second magnetic pole and adjacent to the second magnetic pole, with respect to the rotational direction of the first rotatable member, and having a different magnetic polarity as that of the second magnetic pole, and a fourth magnetic pole provided downstream of the third magnetic pole and adjacent to the third magnetic pole, with respect to the rotational direction of the first rotatable member, and having a same magnetic polarity as that of the third magnetic pole;
a second rotatable member disposed to face the first rotatable member and configured to receive the developer delivered from the first rotatable member by a magnetic field generated by the first magnet, the second rotatable member being configured to carry and feed the developer after developing the electrostatic latent image into the second chamber to collect the developer in the second chamber;
a second magnet provided non-rotatably and stationarily inside the second rotatable member, the second magnet having a fifth magnetic pole having a different magnetic polarity as that of the third magnetic pole, wherein the developer after developing the electrostatic latent image is delivered from the first rotatable member to the second rotatable member by a magnetic field generated between the third magnetic pole and the fifth magnetic pole; and
a duct portion including
a suction port that is an inlet through which the developer scattered in the developing container is sucked, the duct portion being extended upstream, in the rotational direction of the second rotatable member, from the suction port,
a first duct wall disposed to face the second rotatable member, and
a second duct wall disposed to face the second rotatable member, and also disposed to face the first duct wall and configured to form a space through which the developer sucked from the suction port flows between the second duct wall and the first duct wall, the second duct wall being positioned on an outer side than the first duct wall with respect to a rotation center of the second rotatable member in a radial direction of the second rotatable member,
wherein, in a cross-section orthogonal to a rotational axis of the first rotatable member,
in a state where an edge of the first duct wall on the suction port side, which is an end point on the second duct wall side, is referred to as a point A, a point on an outer surface of the first rotatable member where an absolute value of magnetic flux density of the second magnetic pole in a normal direction with respect to the outer surface of the first rotatable member is a maximum value is referred to as a point H, a straight line passing the point A and the point H is referred to as a straight line T, a straight line passing the point H and a rotation center O of the first rotatable member is referred to as a straight line L, and an angle formed by the straight line T and the straight line L is referred to as an angle θ, where θ is an acute angle,
θ ≤ 60° is satisfied.

2. The developing apparatus according to claim 1, wherein
θ ≤ 40° is satisfied.

3. The developing apparatus according to claim 1, wherein
30° < θ is satisfied.

4. The developing apparatus according to claim 1, wherein in the cross-section orthogonal to the rotational axis of the first rotatable member,
in a state where the rotation center O of the first rotatable member is positioned on a left side of a rotation center O’ of the second rotatable member,
the point A and the rotation center O’ of the second rotatable member are positioned in a first quadrant of a coordinate plane constituted of an x axis in a horizontal direction and a y axis in a vertical direction with the rotation center O of the first rotatable member set as an origin.

5. The developing apparatus according to claim 4, wherein
in the cross-section orthogonal to the rotational axis of the first rotatable member,
the point A is positioned in a second quadrant of a coordinate plane constituted of an x axis in a horizontal direction and a y axis in a vertical direction with the rotation center O’ of the second rotatable member set as an origin.

6. The developing apparatus according to claim 1, wherein
in the cross-section orthogonal to the rotational axis of the first rotatable member,
in a state where a point on an inner wall surface, which is a wall surface on the second duct wall side, of the first duct wall, being positioned upstream of the point A in the rotational direction of the second rotatable member, is referred to as a point B, a straight line passing the point B and the point H is referred to as a straight line F, and an angle formed by the straight line F and the straight line L is referred to as an angle φ, where φ is an acute angle,
a first surface of the inner wall surface on the point A side from the point B is inclined with respect to a second surface of the inner wall surface on an opposite side of the point B from the point A, and
φ ≤ 60° is satisfied.

7. The developing apparatus according to claim 6, wherein
φ ≤ 40° is satisfied.

8. The developing apparatus according to claim 6, wherein
θ < φ is satisfied.

9. The developing apparatus according to claim 6, wherein
in the cross-section orthogonal to the rotational axis of the first rotatable member,
in a state where the rotation center O of the first rotatable member is positioned on a left side of a rotation center O’ of the second rotatable member,
the point B is positioned in a first quadrant of a first coordinate plane constituted of an x axis in a horizontal direction and a y axis in a vertical direction with the rotation center O of the first rotatable member set as an origin, and is positioned in a first quadrant or a second quadrant of a second coordinate plane constituted of an x axis in a horizontal direction and a y axis in a vertical direction with the rotation center O’ of the second rotatable member set as an origin.

10. The developing apparatus according to claim 1, wherein
the second magnet further has a sixth magnetic pole provided upstream of the fifth magnetic pole and adjacent to the fifth magnetic pole with respect to the rotational direction of the second rotatable member, and having a different magnetic polarity as that of the fifth magnetic pole, and
in a state where a point on an outer surface of the second rotatable member where an absolute value of magnetic flux density of the sixth magnetic pole in a normal direction with respect to the outer surface of the second rotatable member is a maximum value is referred to as a point J, a straight line passing the point J and the rotation center O’ of the second rotatable member is referred to as a straight line E, a straight line passing the point A and the rotation center O’ of the second rotatable member is referred to as a straight line G, and an angle from a line segment A-O’ of the straight line G between the point A and the rotation center O’ of the second rotatable member to a line segment J-O’ of the straight line E between the point J and the rotation center O’ of the second rotatable member, with respect to the rotational direction of the second rotatable member, is referred to as an angle ψ,
ψ > 0 is satisfied.

11. The developing apparatus according to claim 10, wherein
ψ ≥ 5° is satisfied.

12. The developing apparatus according to claim 10, wherein
ψ ≥ 10° is satisfied.

13. The developing apparatus according to claim 10, wherein
ψ ≤ 30° is satisfied.

14. The developing apparatus according to claim 10, wherein
ψ ≤ 20° is satisfied.

15. The developing apparatus according to claim 10, wherein
the point J is positioned lower than the point A in a vertical direction.

16. The developing apparatus according to claim 10, wherein
in a state where a point on an outer surface of the first rotatable member where an absolute value of magnetic flux density of the third magnetic pole in a normal direction with respect to the outer surface of the first rotatable member is a maximum value is referred to as a point U, a point on an outer surface of the second rotatable member where an absolute value of magnetic flux density of the fifth magnetic pole in a normal direction with respect to the outer surface of the second rotatable member is a maximum value is referred to as a point V, a straight line passing the rotation center O of the first rotatable member and the rotation center O’ of the second rotatable member is referred to as a straight line O-O’, an angle from the point U to a first intersection point on an outer periphery surface of the first rotatable member where the straight line O-O’ intersects the outer periphery surface of the first rotatable member, with respect to the rotational direction of the first rotatable member, is referred to as an angle α, and an angle from the point V to a second intersection point on an outer periphery surface of the second rotatable member where the straight line O-O’ intersects the outer periphery surface of the second rotatable member, with respect to the rotational direction of the second rotatable member, is referred to as an angle β,
α < β is satisfied.

17. The developing apparatus according to claim 16, wherein
the point U is positioned downstream of the point H and upstream of the first intersection point with respect to the rotational direction of the first rotatable member, and
5° ≤ α ≤ 30° is satisfied.

18. The developing apparatus according to claim 16, wherein
the point V is positioned downstream of the point J and upstream of the second intersection point with respect to the rotational direction of the second rotatable member, and
5° ≤ β ≤ 30° is satisfied.

19. The developing apparatus according to claim 1, wherein
the second duct wall is extended downstream in the rotational direction of the second rotatable member than the edge of the first duct wall on the suction port side.

20. The developing apparatus according to claim 1, wherein
the first magnet further has a seventh magnetic pole provided downstream of the first magnetic pole and adjacent to the first magnetic pole with respect to the rotational direction of the first rotatable member, and having a different magnetic polarity as that of the first magnetic pole, and a eighth magnetic pole provided downstream of the seventh magnetic pole and adjacent to the seventh magnetic pole with respect to the rotational direction of the first rotatable member, and having a different magnetic polarity as that of the seventh magnetic pole, and
wherein the second magnetic pole is provided downstream of the eighth magnetic pole and adjacent to the eighth magnetic pole with respect to the rotational direction of the first rotatable member, and having a different magnetic polarity as that of the eighth magnetic pole.
